(19) United States
(12) Patent Application Publication
(10) Pub. No.: US 2012/0145256 A1
(43) Pub. Date: Jun. 14, 2012

(54) LINEAR AND LOGARITHMIC CONCENTRATION GRADIENT GENERATORS

(76) Inventors: Danny Van Noort, Singapore (SG); Hanry Yu, Singapore (SG)

(21) Appl. No.: 13/257,292

(22) PCT Filed: Mar. 16, 2010
(86) PCT No.: PCT/SG2010/000094

§ 371 Date: Dec. 27, 2011

Related U.S. Application Data
(60) Provisional application No. 61/160,791, filed on Mar. 17, 2009.

(51) Int. Cl. G05D 11/00

(52) U.S. Cl. 137/88

(57) ABSTRACT

The present invention refers to microfluid concentration gradient generators, in particular a linear concentration gradient generator and a logarithmic concentration gradient generator, each relying on a particular configuration of interconnecting channels to achieve the required concentration gradient.

### TECHNICAL FIELD

The present invention refers to concentration gradient generators, such as a linear concentration gradient generator and a logarithmic concentration gradient generator.

### BACKGROUND

Gradient concentration generators are used to generate a range of concentrations from two or more fluidic inlets. In the simplest form, two inlets are used to mix two solutions to a defined concentration, depending on the architecture of the generator. It can be envisioned that more solutions from multiple inlets can be mixed as well, to form a complex solution space. A Gradient concentration generator generates fluid flow exiting through a plurality of outlets, and the concentrations of the fluid flow exiting through different outlets may vary linearly, logarithmically, sigmoidally, expotentially, quadraticly, sinusoidally, squaredly, and cubedly, etc. It is for example also possible to use a flow rate gradient generator. Flow rate gradient generators are used to generate a range of flow rates.

It is an object of the present invention to provide new concentration gradient generators which are suitable for chemical or biological or medical or research applications.

### SUMMARY OF THE INVENTION

In one example, an apparatus for linear gradient generation is provided. The apparatus comprises a first generation having at least two first generation channels. The apparatus further has a second generation having at least four second generation channels, each second generation channel having an inlet and an outlet, the inlet of each second generation channel being in communication with one of the at least two first generation channels, the outlet of each being in communication with the outlet of one of the other second generation channels, at a crossing point, wherein the inlet of the other second generation channel is in communication with another first generation channel. The apparatus further has a third generation having at least three third generation channels, each third generation channel having an inlet and an outlet. The apparatus comprises further at least one control channel being connected to one of the at least two first generation channels, the at least one control channel having an inlet and an outlet, wherein the inlet of the at least one control channel is connected with one of the at least two first generation channels, and the outlet of the at least one control channel is connected with one of the at least three third generation channels. A crossing point between two second generation channels is in communication with an inlet of one of the at least three third generation channels. The dimensions of the second generation channels that are in communication with a same first generation channel are chosen such that the fluid flow resistances of the second generation channels vary linearly. The sum of fluid flow resistances of any of the two second generation channels that are in communication with each other is of a predetermined value. The fluid flow resistance of the first generation channels is smaller than the fluid flow resistance of the second generation channels.

In one example, an apparatus for logarithmic gradient generation is provided. The apparatus comprises a first generation having a first generation channel, the first generation channel having an inlet, an outlet, and a connection node located in between the inlet and the outlet of the first generation channel. The apparatus further comprises a first connection channel having an inlet and an outlet, wherein the inlet of the first connection channel is connected to the first generation channel at the connection node of the first generation channel. The apparatus further comprises a second generation having a second generation channel, the second generation channel having an inlet, an outlet, and a first connection node located in between the inlet and the outlet of the second generation channel. The first connection node of the second generation channel is connected to the first connection channel at the outlet of the first connection channel.

In one example, a kit is provided, the kit comprising a first module comprising a linear gradient generator described herein. In one example, the kit further comprises a second module comprising a plurality of biological material cultivation chambers. In one example, the outlets of the third generation channels of the linear gradient generator are connected to inlets of the plurality of biological material cultivation chambers.

In one example, a kit is provided, the kit comprising a first module comprising a logarithmic gradient generator described herein. In one example, the kit further comprises a second module comprising a plurality of biological material cultivation chambers. In another example, the outlets of the generation channels of the logarithmic gradient generator are connected to inlets of the plurality of biological material cultivation chambers.

In one example, a kit is provided, the kit comprising a first module comprising a linear gradient generator described herein and/or a logarithmic gradient generator described herein. In one example, the kit further comprises a second module comprising a plurality of biological material cultivation chambers. In one example, the outlets of the third generation channels of the linear gradient generator are connected to inlets of the plurality of biological material cultivation chambers. In one example, the outlets of the generation channels of the logarithmic gradient generator are connected to inlets of the plurality of biological material cultivation chambers.

In one example, a method of subjecting a biological material located in a cultivation chamber for a test substance, is provided, the method comprises providing a linear gradient generator described herein. In another example, the method further comprises providing a plurality of cultivation chambers, each retaining a biological material. In a further example, the method further comprises introducing a cultivation medium through an inlet into one of the two first generation channels of the linear gradient generator, and introducing a test substance through an inlet into the other first generation channel of the linear gradient generator, whereby the cultivation medium or the test substance or a mixture of the cultivation medium and the test substance is obtained at the outlet or outlets of each third generation channel of the linear gradient generator. In one example, the method further comprises letting each of the mixtures or the cultivation medium or the test substance flow through at least one of the plurality of cultivation chamber which retains the biological material.

In one example, it is provided a method of subjecting a biological material located in a cultivation chamber to a test substance, the method comprising providing a logarithmic gradient generator described herein. In another example, the method further comprises providing a plurality of cultivation chambers, each retaining a biological material. In a further example, the method further comprises introducing a test substance through an inlet into the first generation channel of the logarithmic gradient generator and introducing a cultivation medium through an inlet into other generation channels of the logarithmic gradient generator, whereby the test substance or a mixture of the cultivation medium and the test substance is obtained at the outlet or outlets of each generation channel of the logarithmic gradient generator. In one example, the method further comprises letting each of the mixtures or the test substance flow through at least one of the plurality of cultivation chambers which retains the biological material.

In one example, a method of subjecting a biological material located in a cultivation chamber to a test substance is provided, the method comprising providing a linear gradient generator described herein and providing a logarithmic gradient generator described herein. In one example, the method further comprises providing a plurality of cultivation chambers, each retaining the biological material. In another example, the method further comprises introducing a cultivation medium through an inlet into one of the two first generation channels of the linear gradient generator, and introducing a test substance through an inlet into the other first generation channel of the linear gradient generator, whereby the cultivation medium or the test substance or a mixture of the cultivation medium and the test substance is obtained at the outlet or outlets of each third generation channel of the linear gradient generator. In one example, the method further comprises letting each of the mixtures or the cultivation medium or the test substance flow through at least one of the plurality of cultivation chambers which retains the biological material. In one example, the method further comprises introducing a test substance through an inlet into the first generation channel of the logarithmic gradient generator and introducing a cultivation medium through an inlet into other generation channels of the logarithmic gradient generator, whereby the test substance or a mixture of the cultivation medium and the test substance is obtained at the outlet or outlets of each generation channel of the logarithmic gradient generator. In one example, the method further comprises letting each of the mixtures or the test substance flow through at least one of the plurality of cultivation chambers which retains the biological material.

### BRIEF DESCRIPTION OF THE DRAWINGS

The invention will be better understood with reference to the detailed description when considered in conjunction with the non-limiting examples and the accompanying drawings, in which:

FIG. 1 shows the conversion of Ohm's and Kirchoff's laws from electric (left side) to fluidic parameters (right side) for illustrating the similarity of the use of Ohm's and Kirchoff's laws in both electric circuits and the fluidic circuits;

FIG. 2 shows the structure of a linear concentration gradient generator and the resistance (e.g. 2, 3, 4, 5, etc.) distribution of different channels/segments of the linear concentration gradient generator according to one example;

FIG. 3 shows an illustration of an electric circuit, the working mechanism of which is similar to a fluidic circuit;

FIG. 4 shows simulation results of normalized mixing ratio over each channel for a linear concentration gradient generator according to one example, and the results show that the fluid flow exiting from the outlets of such a linear gradient generator gives an almost linear variation of the concentration of the at least one chemical substance within the solution;

FIG. 5 illustrates that changing the resistances of control channels leads to a change in linear performance, wherein the change of the resistance of control channels can lead to an imbalance of the flow rates at different outlets;

FIG. 6 shows an illustration of the dimensions of a linear concentration gradient generator used for simulations; however, the dimensions are not limited to the values shown in FIG. 6. The dimensions indicated in FIG. 6 are given in mm. In one example, in connection with FIG. 2, the diameter of the narrow channels (i.e. channels 205, 206, 218, 219 etc) is 50 μm, while the diameter of wide channels (i.e. channels 201, 202) is 200 μm. The diameter used herein refers to inner diameter of a channel/segment.

FIG. 7 shows an example in which an outlet of a concentration gradient generator 709 further divides into a plurality of outlets 701. In this example, the plurality of outlets 701 of the gradient generation is fluidly connected to a biological material cultivation chamber 702. The biological material cultivation chamber 702 further comprises a plurality of outlets 703 merging in one single outlet 708;

FIG. 8 illustrates the principle underlying the logarithmic distribution for the logarithmic concentration gradient generator, wherein the flow rates (e.g. 10, 9, 1) in different channels/segments, and the concentrations (e.g. 10⁰, 10⁻¹) at different outlets of different channels are indicated in FIG. 8;

FIG. 9 illustrates the structure for the logarithmic concentration gradient generator. The numbers shown in FIG. 9 indicate the nodes for inlets (e.g. 1, 4, 8, 12 etc.), outlets (e.g. 3, 7, 11, 15, 19 etc.) and channel junctions (e.g. 2, 5, 6, 9, 10, etc.);

FIG. 10 illustrates the resistance values for the structure shown in FIG. 9. R refers to the resistance, e.g. R_{9 10} indicates the relative resistance of the channel lying between nodes 9 to 10; R_{9 10}=9 indicates that the relative resistance of the channel lying between nodes 9 and 10 is 9. In this regard, “relative resistance” refers to a relative value of the resistance of the channel with reference to the resistance of other channels/segments. For example, FIG. 10 shows that the relative resistance R_{1 2}=1, and R_{9 10}=9. This means the R_{9 10} is 9 times R_{1 2}. When R_{1 2} is 1Ω, R_{9 10} is 9Ω, and when R_{1 2} is 3Ω, R_{9 10} is 27Ω.

FIG. 11 illustrates a schematic overview of the logarithmic concentration gradient generator according to one example, wherein the relative lengths of different channels are shown;

FIG. 12 illustrates results of simulation conducted on a logarithmic concentration gradient generator as described herein. The simulation demonstrates the normalized mixing percentage of a solution in the fluid flow exiting from the outlet over each channel for the logarithmic concentration gradient generator according to one example;

FIG. 13 illustrates the dimensions of the logarithmic concentration gradient generator used for simulations; however, the dimensions are not limited to the values shown in FIG. 13. In one example, the diameter of the channels/segments can be in the range between about 20 μm and about 200 μm.

FIG. 14 illustrates results of a simulation conducted on a logarithmic concentration gradient generator as described herein. The simulation demonstrates the mixing of the medium and the solution comprising at least one chemical substance. The changing colors show that the mixing of the medium and the solution leads to a dilution of the solution;

FIG. 15 shows a top view of a microfluidic continuous flow device comprising an area 1501 including multiple cultivation chambers 1504 and their respective inlet 1505 and outlet channels 1503 and an area 1502 comprising the concentration gradient generator 200 and the inlets 203 and 204 of the concentration gradient generator 200;

FIG. 16A shows a kit comprising a first module 1601 and a second module 1602. The first module 1601 may comprise at least one gradient generator. The second module 1602 may comprise a plurality of biological material cultivation chambers. The outlets of the at least one gradient generator are fluidly connected to the inlets of the plurality of biological material cultivation chambers;

FIG. 16B shows a kit comprising a first module 1601, a second module 1602, and a third module 1603. The first module 1601 and the second module 1602 are analogous to the modules shown in FIG. 16A. The third module 1603 provides channels which fluidly connect the outputs of the gradient generator in the first module 1601 and the inlets of the biological material cultivation chambers in the second module 1602;

FIG. 17 shows an experimental photo of a kit comprising a first module which has a gradient generator 1701, and a second module which has a plurality of biological material cultivation chambers 1702. In the example shown in FIG. 17, each of the eight outlets of the gradient generator which provides a solution with a different concentration of a certain substance, splits up or divides into two outlets. Thus, the gradient generator now provides two outlets for every dilution of the substance, i.e. in total 2*8=16 outlets. Those outlets are fluidly connected to the inlets of the biological material cultivation chambers 1702;

FIG. 18 illustrates the channels 1801 comprised in a third module, each having an inlet 1802 and two outlets 1803, wherein the inlet can be fluidly connected to an outlet of a gradient generator, and the outlets 1803 can be fluidly connected to the inlet of at least one biological material cultivation chamber;

FIG. 19 illustrates a microfluidic continuous flow device which comprises a plurality of biological material cultivation channels 1904, wherein the microfluidic continuous flow device has an inlet 1901 for a biological material input, and wherein each biological material cultivation chamber 1904 has two inlets 1903 for cultivation medium input. Outlets of a gradient generator can be fluidly connected to the inlets 1903 of the microfluidic continuous flow device directly or via channels such as the channels illustrated in FIG. 18;

FIG. 20 shows an example of a channel of a microfluidic continuous flow device. The second inlet feeding line 2001 feeds the channel 2002 with cultivation medium which enters the channel through the second inlet and exits the channel through the outlet 2003. 2004 shows an additional exit channel fluidly connecting the outlet with the channel 2002. Also shown is the first inlet 2005 through which the biological material 2006 is introduced into the compartment 2007 of the channel 2002. The compartment 2007 is defined by partitioning elements 2008. Also shown are the medium flow separator 2009 and 2010.

### DETAILED DESCRIPTION OF THE INVENTION

### Linear Concentration Generator

In the present invention, microfluidic technology to construct a linear concentration generator is used. The present invention provides, in one aspect, a linear concentration gradient generator including multiple generations. Only two inlets are required, one for a medium and one for a chemical solution, such as drugs/pharmaceuticals and toxins.

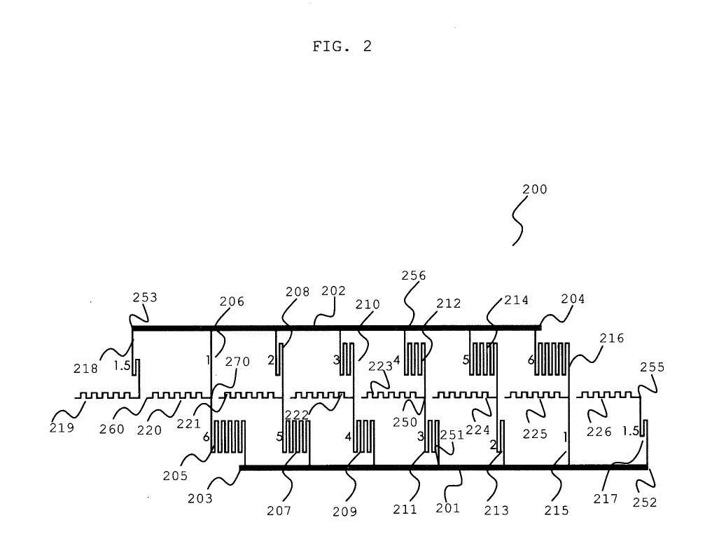

As used herein, for the linear concentration gradient generator, the term “generation” may refer to a part of the device of a linear concentration gradient generator trough which solution comprising at least one chemical substance at a certain concentration is flowing. For example, FIG. 2 shows a linear concentration gradient generator 200. The medium enters the main channel 201 of the device 200 through an inlet 203, and the main channel 201 is therefore called first generation channel. Then the fluid flow enters branches such as branch 211, and therefore the branch 211 is called the second generation channel. The fluid flow in the channels 211 and 212 then enters the sub-branch 223, and therefore the sub-branch 223 is called the third generation channel.

In one example, the structure of the linear concentration generator is the one shown in FIG. 2. The numbers indicate the relative resistance of each microfluidic channel section. As used herein, the term “solution” may refer to a solution consisting of a chemical substance such as drugs/pharmaceuticals, toxins, dyes, growth factors (protein mixtures), or mixtures of the aforementioned substances etc.

In one example, the linear concentration gradient generator may comprise two main channels (first generation channels), wherein the medium enters the device through one end of a main channel, and the solution comprising the chemical substance enters the device through one end of another main channel. For example, FIG. 2 shows an illustration of the structure of the linear concentration gradient generator 200. The linear concentration gradient generator 200 comprises two main channels 201 and 202, wherein the medium enters through one end, i.e. 203 of a main channel, i.e. 201, and the solution comprising at least one chemical substance enters through one end, i.e. 204 of another main channel 202. In one example, the solution contains a certain amount of at least one chemical substance.

In another example, each main channel is connected to a plurality of branch channels (second generation channels). For example, referring to FIG. 2, main channel 201 is connected to branch channels 205, 207, 209, 211, 213, and 215, and main channel 202 is connected to branch channels 206, 208, 210, 212, 214, and 216. In one example, each branch channel has two ends, and is connected to a main channel at one end of the branch channel, and the other end of the branch channel is connected to another branch channel that is connected to another main channel at a crossing point/node. For example, branch channel 211 can have two ends 250 and 251, and is connected to the main channel 201 at one end 251 of the branch channel 211, and the other end 250 of the branch channel 211 is connected to another branch channel 212 via the end/crossing point/node 250 of the branch channel 211, wherein the branch channel 212 is connected to another main channel 202 at another end 256 of the branch channel 212. In one example, a sub-branch channel (third generation channel) is connected to each crossing point node at one end of the sub-branch channel. For example, a sub-branch channel 223 is connected to the crossing point 250 at one end of the sub-branch channel 223.

In one example, the sum of fluid flow resistances of every pair of branch channels that are connected to each other via crossing points is of the same value. For example, referring to FIG. 2, the sum of fluid flow resistance of channel 205, which is 6 as indicated in FIG. 2, and fluid flow resistance of channel 206, which is 1 as indicated in FIG. 2, is of the same value, namely 7. The sum of the fluid flow resistance is also 7 for channel 207 having a flow resistance of 5 as indicated in FIG. 2 and channel 208 having a flow resistance of 2 as indicated in FIG. 2.

For example, the fluid flow resistance of branches which are connected with the same main channel can vary linearly. For example, referring to FIG. 2, the fluid flow resistance of branches 205, 207, 209, 211, 213, and 215 that are connected to the same main channel 201 varies linearly. That means that the relative fluid flow resistances of branches 205, 207, 209, 211, 213, and 215 are 6, 5, 4, 3, 2, 1, respectively, and the relative fluid flow resistances of branches 206, 208, 210, 212, 214, and 216 are 1, 2, 3, 4, 5, 6 respectively. As can be seen from this particular example, the sum of each pair of branches that are connected, such as branches 211 and 212, is of the same value, namely 7.

The pattern of the flow concentration of a chemical substance can be influenced by the architecture of a concentration gradient generator. The microfluidic channels form the building block of the device (concentration gradient generator). By changing the resistances of these channels, flow distributions can be altered. The resistance of a channel section can be changed by altering the dimensions of the channel in width, height and/or length. The length is the easiest to calculate, as the resistance changes linear with the length. To calculate the resistance by changing the width or height of the channel, the Navier-Stokes equation for a particular shape of the channel has to be calculated. Different channel shapes (such as circular, rectangular) give different partial equations.

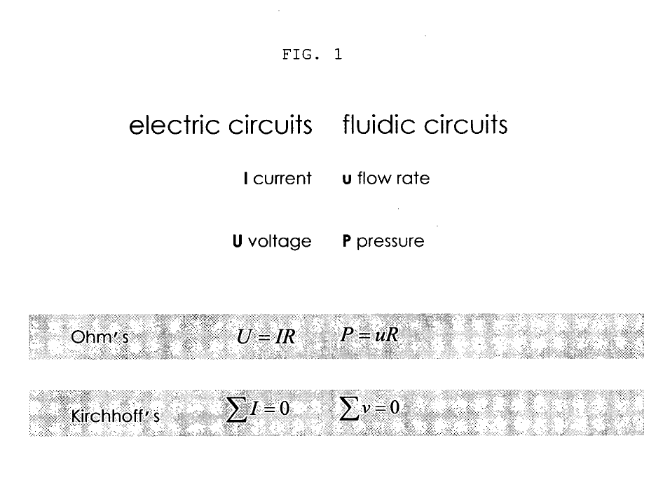

In principle, the Ohm's and Kirchhoff's law can be applied to a fluidic circuit as well as to an electric circuit, with the conversion shown in FIG. 1. The illustration of the similarity of the application of Ohm's law and Kirchhoff's law on the electric circuit and the fluidic circuit is to interpret how the Ohm's law and the Kirchhoff's law works on the fluidic circuit.

Generally, Ohm's and Kirchoff's laws work for electric circuits and fluidic circuits in a similarly way. For electric circuits, according to Ohm's law: U=IR, wherein U is voltage, I is electric current, and R is resistance. Similarly, for the fluidic circuits, according to Ohm's law: P=uR, wherein P is pressure of fluidic flow, u is flow rate, and R is fluid flow resistance.

For electric circuits, according to Kirchoff's law: ΣI=0, meaning that at every electric circuit node/connection point/crossing point, the sum of all the electric current at the electric current node is zero. This holds true when we define that the electric current that flows into the node is positive, and the electric current that flows out of the node is negative.

Similarly, for fluidic circuits, according to Kirchoff's law: Σu=0, meaning that at every fluidic circuit node/connection point/crossing point, the sum of all the fluid flow at the fluidic circuit node is zero. This holds true when we define that the fluid flow that flows into the node is positive, and the fluid flow that flows out of the node is negative.

Navier-Stokes equation, which is well known in the art (Frank M. White, Fluid Mechanics, 1994, 3^{rd} edition, McGRAW-HILL, INC, p. 205), may be used to derive the fluid flow rate in a channel: (flow in x-direction)

$${∇}^{2} u = \frac{1}{μ} \frac{d p}{d x} \qquad ( 1 )$$

with u is the flow rate and μ is the viscosity and p is the pressure.

The partial-differential equation in Equ. (1) can be further expressed as:

$${∇}^{2} u = \frac{1}{μ} \frac{Δ p}{l} \qquad ( 2 )$$

Thus, the volumetric flow rate Q can be expressed as:

$$Q = - \frac{1}{R} \frac{Δ p}{l} \qquad ( 3 )$$

where R is the specific resistance. Here, the specific resistance may refer to resistance per unit length of the channel, and the volumetric flow rate may refer to volume of fluid which passes through a given surface per unit time. The total resistance over the channel is

Rₜ=Rl

where l is the length of the channel. Thus,

−Δp=RₜQ

From the above equations, it is possible to solve the flow distribution for the gradient generator.

As an illustration, for a rectangular channel with sides a and b, volumetric flow rate is:

$$Q = \frac{Δ p}{μ l} \frac{1}{24} a b ( {a}^{2} + {b}^{2} ) - \frac{Δ p}{μ l} \frac{8}{{π}^{5}} {\sum }_{n = 1}^{∞} \frac{1}{{( 2 n - 1 )}^{5}} [ {a}^{4} tanh ( \frac{2 n - 1}{2 a} π b ) + {b}^{4} tanh ( \frac{2 n - 1}{2 b} π a ) ]$$

Also in this example, other than the linear gradient generator disclosed in the art (G. M. Walker et al. Lab on a Chip, 2007, 7, 226-232), each main channel can further be connected with a control channel at one end of the control channel. For example, in FIG. 2, the main channel 201 is connected to a control channel 217 at one end 253 of the control channel 217, and the main channel 202 is connected to a control channel 218 at one end 253 of the control channel 218. In one example, the other end of the control channel is connected with a sub-channellsub-branch channel. For example, the other end 255 of the control channel 217 is connected with a sub-branch 226.

In other words, the linear concentration generator may comprise a first generation having at least two first generation channels (main channels). In one example, the linear concentration generator may comprise a second generation having at least four second generation channels (branch channels), each second generation channel having an inlet and an outlet, the inlet of each second generation channel being in communication with one of the at least two first generation channels (main channels), the outlet of each being in communication with the outlet of one of the other second generation channels, at a crossing point, wherein the inlet of the other second generation channel is in communication with another first generation channel. In one example, the linear concentration generator may comprise a third generation having at least three third generation channels (sub-channel/sub-branch channel), each third generation channel having an inlet and an outlet. In one example, the linear concentration generator may comprise at least a control channel being connected to one of the at least two first generation channels, the at least a control channel having an inlet and an outlet, wherein the inlet of the at least a control channel is connected with one of the at least two first generation channels, and the outlet of the at least a control channel is connected with one of the at least three third generation channels. In one example, a crossing point between two second generation channels is in communication with an inlet of one of the at least three third generation channels. In another example, the dimensions of the second generation channels that are in communication with a same first generation channel are chosen such that the fluid flow resistances of the second generation channels vary linearly. In one example, the sum of the fluid flow resistance of any two second generation channels that are in communication with each other is a predetermined value. In one example, fluid flow resistances of the first generation channels are lower than the fluid flow resistances of the second generation channels.

In one example, each of the at least three third generation channels is of serpentine shape including multiple turns. For example, referring to FIG. 2, each sub-branch channel, such as 219 is of serpentine shape including multiple turns.

In a further example, the fluid flow resistance of second generation channels can be varied differently by changing the length or height or width of the channels. For example, the fluid flow resistance of second generation channels, such as second generation channels 205-216, can be varied differently by changing the length or height or width of the channels. In a particular example, the relative resistance of second generation channels 205, 207, 209, 211, 213, and 215 are 6, 5, 4, 3, 2, 1, respectively, and the resistance of the second generation channels 205, 207, 209, 211, 213, and 215 are varied by changing the length of the channels. As can be seen, for example, channel 205, which has a higher fluid flow resistance of 6, is much longer compared to channel 215, which has a lower relative fluid flow resistance of 1.

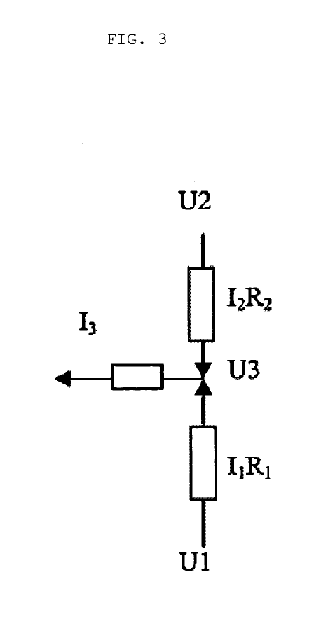

The mechanism of the linear concentration gradient generator is interpreted in more detail as follows. According to the Ohm's law: P=uR, wherein u is the flow rate, and R is resistance. In this regard, the Ohm's law applies to a fluid flow similarly as to an electrical circuit. For example, FIG. 3 illustrates an electric circuit.

In FIG. 3, the following relationship exists:

U₃=U₁−I₁R₁=U₂−I₂R₂;

I₃=I₁+I₂

Should U₁=U2, then I₁R₁=I₂R₂

Similarly, for the fluid flow system as shown in FIG. 2, if the injecting pressures at both inlets 203 and 204 are equal, then u₁R₁=u₂R₂.

Thus, the linear gradient generator 200 as shown in FIG. 2 works when the injecting pressures of fluid flow rate at two inlets 203 and 204 are equal. Otherwise, the generator with the resistance relationship of branch channels (second generation channels) defined above would not lead to the fluid flow exiting from the outlets with a linear concentration gradient.

The flow rate may define the amount of liquid which passes through a given cross section of the channel, which plays a role in the correct mixing ratio.

However, it is also possible to provide a linear gradient generator working with two different flow rates at the two inlets 203 and 204. In this case, the resistance of the channels needs to be adjusted to still obtain a linear gradient at the outlets of the linear gradient generator.

The section area of a channel, which is the product of width and height of the channel, can influence the resistance of the channel. A larger section area can lead to a smaller resistance of the channel, wherein a smaller resistance can contribute to an increase of the flow rate. On the other hand, a larger section area, and hence a larger volume of the channel can contribute to a decrease of the flow rate. Thus, whether an increase of the section area can lead to an increase or a decrease of the flow rate depends on which factor (resistance or volume) is dominant, which means that if the change of fluid flow resistance is dominant when increasing the section area, then the flow rate can be reduced, and if the change of volume is dominant when increasing the section area, then the flow rate can be increased.

Assuming a given constant flow rate, when enlarging the section area of the channel the flow rate at that point, as well as the pressure, can decrease. Reducing the section area of the channel can lead to an increase of flow rate and pressure at that point.

The length of a channel is a parameter which can be used to change the fluid flow resistance of the channel, because the fluid flow of the channel changes linearly with the length of the channel. Given a same section area of the channel, the longer the channel the larger the fluid flow resistance. It is possible to vary the resistance of the channel in any way, by lengthening, or changing the width and depth. However, it is much easier to change the resistance by changing the length, as the Navier-Stokes equation does not need to be solved for a certain channel cross section shape. Accordingly, with reference to FIG. 2, the second generation channels (205-216) are with different lengths, and thus have different resistances. For example, channel 205 which has a resistance of 6 is much longer than channel 215 which has a resistance of 1 as indicated in FIG. 2.

A longer length (not considering the section area) of the channel would lead to a higher resistance in the channel, and hence leads to a lower flow rate of the liquid in the channel. The difference of the flow rates between two mixing branches would lead to different concentrations in the mixed channel. This is because at the branching points (nodes) the branch guiding the liquid stream with the higher flow rate contributes a greater amount of liquid to the mixture created at the node than the branch guiding the liquid stream with the lower flow rate. Thus, different amounts of liquid are mixed with each other which results in dilution of the concentration of any substance comprised in the branch guiding the liquid stream with the lower flow rate. In operation, for example, referring to FIG. 2, the medium enters the device 200 through the inlet 203 at the same pressure/flow rate as the solution enters the device 200 through the inlet 204. Then the medium enters or passes into the second generation channel 205, and the flow rate of the medium reduces when the medium passes the channel 205 due to the resistance of the channel 205. Similarly, the solution enters the second generation channel 206, and the flow rate of the solution reduces as the solution passes the channel 206 due to the resistance of the channel 206. As mentioned early with reference to FIG. 3, when the pressure of the medium and solution at the inlets 203 and 204 is the same, the following formula satisfies: u₂₀₅R₂₀₅=u₂₀₆R₂₀₆, wherein u₂₀₅ is the flow rate in channel 205, and R₂₀₅ is the resistance of channel 205, u₂₀₆ is the flow rate in channel 206, and R₂₀₆ is the resistance of channel 206. As the relative resistance of channel 205 is 6, which is 6 times the resistance of channel 206, the flow rate in channel 205 is then 1/6 of the flow rate in channel 206. Thus, the solution in channel 206 contributes 6/1+6) to the flow in the third generation channel 220, and the medium in channel 205 contributes 1/(1+6) to the flow in the third generation channel 220. After mixing of the medium from channel 205 and the solution from channel 206 in the third generation channel 220, the fluid flow exiting from outlet 260 of channel 220 contains 6/7×100% solution, and 1/7×100% medium. The mixing of medium and solution in other pairs of second generation channels (channels 207 and 208; channels 209 and 210; channels 211 and 212; channels 213 and 214; channels 215 and 216) takes place in a similar manner.

The linear concentric gradient generator shown in FIG. 2 takes advantage of the linear resistance of the microfluidic channels by lengthening them. For n outlets (excluding the control channel outlets), a channel with a relative resistance 1 (medium) is paired with that of resistance n (solution consisting chemical substance); the next channel with relative resistance 2 (medium) is paired with that of resistance n−1 (solution consisting chemical substance); etc. For example, the linear gradient generator shown in FIG. 2 has 6 outlets (excluding the control channel outlets) through the third generation channels 220-225. For example, node 260 is the outlet of the third generation channel 220. The channel 215 with relative resistance 1 is paired with channel 216 of resistance 6. The channel 213 with relative resistance 2 is paired with channel 214 of resistance 5; etc.

For n outlets, fluid flow exiting from outlet i comprise a percentage of solution of

$${out}_{i} = \frac{i}{n + 1} 100 \% .$$

For example, in FIG. 2, when a fluid flow of solution consisting of at least one chemical substance in a branch 216 with relative resistance 6 mixes with a fluid flow of medium in a branch 215 with relative resistance 1, the resulting fluid flow in channel 225 can consist of (1/7)*100% flow from the branch 216, and (6/7)*100% flow from the branch 215.

Please note that the resistance in the main channels 201 and 202 of the linear gradient generator shown in FIG. 2 is assumed to be negligible due to the wider width when comparing with the resistance of the second generation channels, such as channels 205-216.

In one example, the width of the main channel can be at least 3 times that of the side channels, assuming they all have the same height. The reason is to obtain the so called “garden hose effect”, meaning all side channels will have the same flow rate. Lowering the resistance of the main channel can lead to a parabolic distribution of the flow rate in the side channels.

In one example, to obtain a 0% and 100% medium (or solution consisting of chemical substance) of fluid flow exiting through the outlet, the control channels may be provided and may not be paired. In one example, control channels 217 and 218 are connected directly to the medium and solution inlets 203 and 204, respectively (FIG. 2). The resistance of the control channels 217 and 218 may be estimated to obtain a close linear relationship between the fluid flow exiting through different outlets.

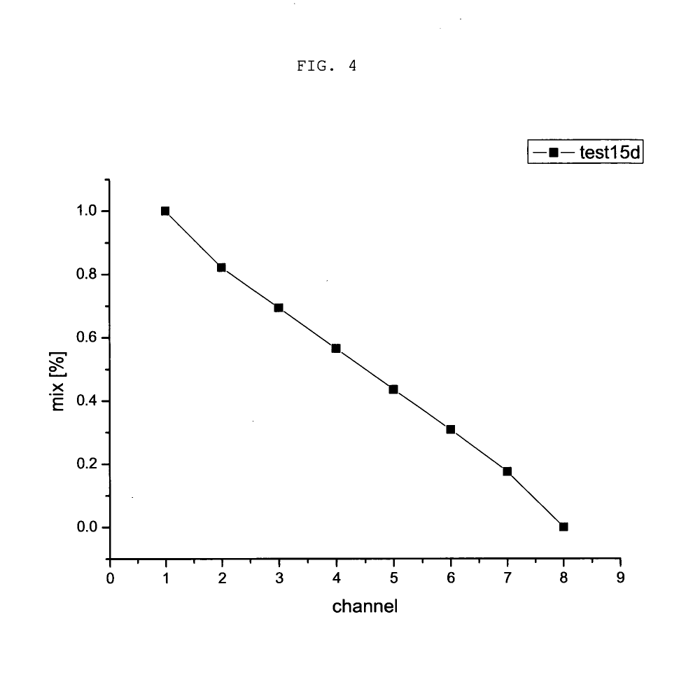

The model in FIG. 2 was subjected to simulations to verify the linearity and flow velocities exiting through the outlet of the generator using software from Coventorware, USA. FIG. 4 shows the results of a good linear relationship of the fluid flow exiting through different outlets.

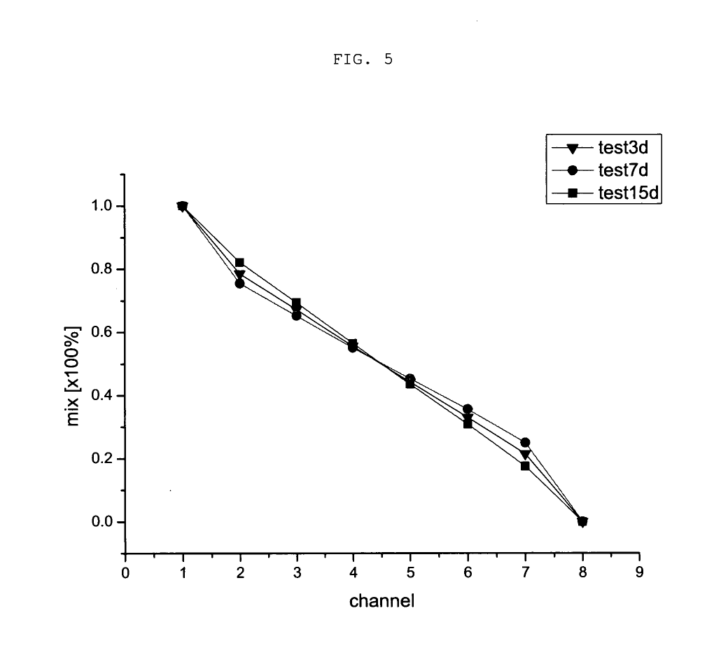

In more detail, the channel numbers 1-8 in the horizontal axis in FIG. 4 correspond to the outlets from the third generation channels 219-226 in FIG. 2, respectively. Note that the solution enters through the inlet 204 and the medium enters through the inlet 203. The vertical axis is the percentage of the solution contained in the flow exiting from the outlets from the third generation channels 219-226. For example, channel number 2 in FIG. 4 corresponds to the third generation channel 220 in FIG. 2, and the value 0.8 corresponding to the channel number 2 in FIG. 4 indicates that flow exiting from the outlet 260 of the third generation channel 220 contains 0.8×100% of solution, namely 80% of solution and 20% of medium. For FIG. 2, the resistance for the control channels 217 and 218 that is not paired with any other branch is set to be 1.5. The resistance value is not set randomly. The value 1.5 has been chosen to allow a better balanced flow rate exiting at the outlets and a better linearity of the distribution of the fluid flow at all 8 outlets. For example, the value of resistance of a control channel may be derived from a simulation as the one exemplified in FIG. 5. Based on the results shown in FIG. 5, one can determine the value of resistance of a control channel by choosing the resistance used in the experiment which leads to the solution concentrations through outlets with the best linear change. In case of the experiments of which the results are shown in FIG. 5, test 15d provided the best linear distribution. The resistance for the experiments which lead to the results illustrated in test 15d is 1.5.

FIG. 5 corresponds to FIG. 4, wherein two sets of data are added for comparison. Other than setting the relative resistance of the control channels to be 1.5, for test 3d and test 7d, the resistance of the control channels is set to be 1 and 2, respectively. In FIG. 5, for Test 15d, the relative resistance is 1.5. FIG. 5 also shows that other selections (test 3d and test7d) of the relative resistance of the control channels do not provide a better linear change of the concentrations at different outlets than the selection of the relative resistance of 1.5 for test 15d. From a series of tests in which the resistance of the control channel is set at different values, a skilled person in the art would be able to determine a suitable value for the resistance of the control channel, which leads to a linear change of concentrations at the different outputs of the linear gradient generator. The reason to have a concentration of 100% and 0% medium (solution consisting of chemical substance) is to have a reference point and control for a 100% solution and 100% medium.

In one example, the typical width for a side channel, such as the second generation channels and third generation channels, may be within the range of 25-100 μm, while the main channels such as 201 and 202 may be within the range of 200-400 μm. Generally speaking, a wider main channel can result in a lower resistance. In one example, in connection with FIG. 2, the diameter of the narrow channels (second generation channels, third generation channels, control channels) is 50 μm, while the diameter of wide channels (first generation channels) is 200 μm.

Flow rates may be between 30 μl/h to 220 μl/h, but higher flow rates are also possible (20 μl/min, namely 1200 μl/h). In case of higher flow rates, the length of the mixing section (the meanders (third generation channels such as 219-226) before the outlets in FIG. 2) might need to be lengthened in order to ensure that mixing of solution and medium is complete.

In one example, the fluid flow in the channels is a laminar flow. In general, laminar flow, sometimes known as streamline flow, occurs when a fluid flows in parallel layers, with no disruption (or turbulence) between the layers.

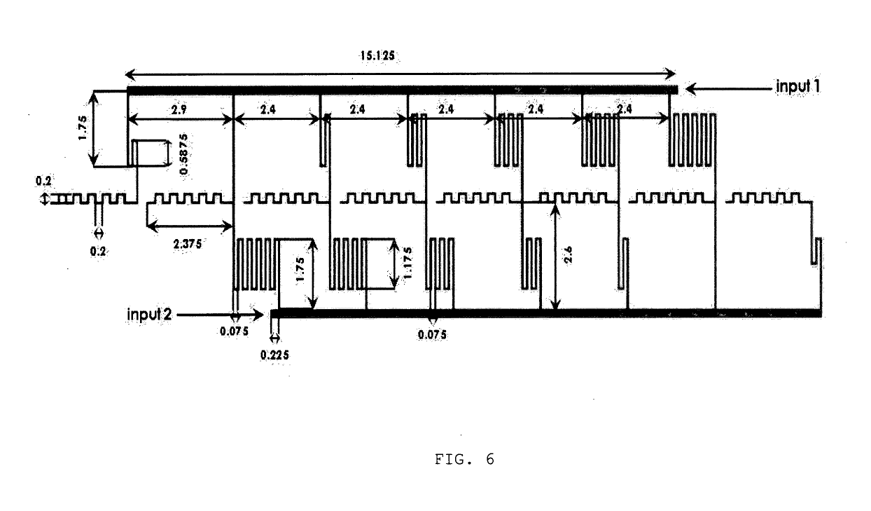

FIG. 6 shows an illustration of the dimensions of the channels of the linear gradient generator shown in FIG. 2. The measurements in the FIG. 6 are in mm. The flow velocity was set at: inlet1=inlet2=2×10⁻² μm/s.

In one example, a mixing meander (third generation channel) is incorporated into the design to facilitate more rapid mixing. In another example, a mixing meaning may have waveform shapes such as sinusoidal wave, triangle wave and pulse wave etc. The mixing meander may have a plurality of turns. Each turn may have an angle of 90 degree (FIG. 2). A control channel may be provided, which is a zero concentration channel where no chemical substance is mixed in. A control channel may be useful as negative control in an experiment.

### Logarithmic Concentration Gradient Generator

In one example, the working of the logarithmic concentration gradient generator is based on the following principle. The first channel, which is the solution inlet, passes 10% of its contents to the next channel in which the 10% solution is mixed with 90% medium. 10% of this mixed, diluted solution is then passed onto the channel. For n outlets, the fluid flow exiting through outlet i comprises a percentage of solution of outᵢ=10⁻ⁱ⁺¹.

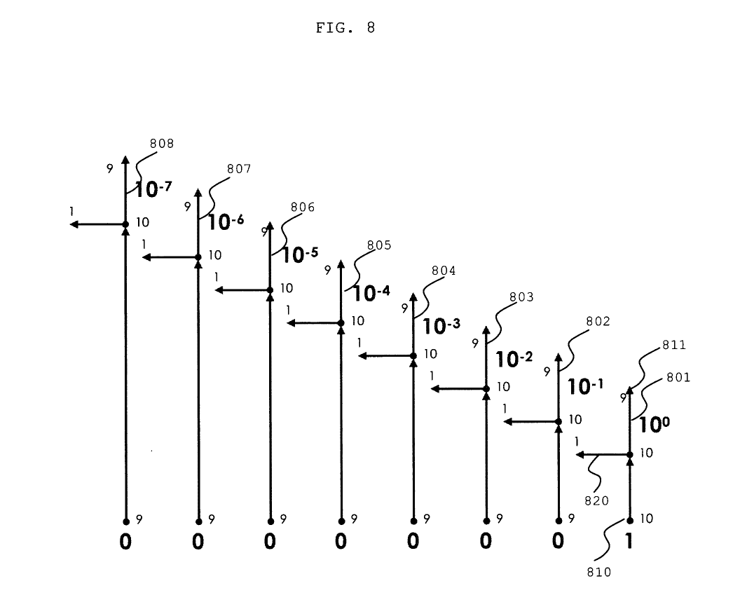

FIG. 8 illustrates the working principle of the logarithmic concentration gradient generator for one specific example. In FIG. 8, there are 8 generation channels 801-808. Channel 801 is the first generation channel and channel 802 is the second generation channel. Each channel has an inlet and an outlet through which the solution or medium enters and exits the logarithmic concentration gradient generator. For example, channel 801 has an inlet 810 and an outlet 811. In this example, the solution enters through the inlet 810 of the first channel 801 at a relative flow rate of 10, and the medium enters through the inlets of the other generation channels at a relative flow rate of 9. Each generation channel can pass 10% of its flow into a next generation channel via a connection channel. For example, the first generation channel 801 passes 10% of its flow into the second generation channel 802 via the connection channel 820. The bottom large numbers in FIG. 8 indicate the type of solution: 0 is the medium, 1 is the solution consisting of at least one chemical substance. The small numbers indicate the flow velocity in each section/channel. For example, the relative flow rate at all the outlets is 9, and the flow rate in the connection channel 820 is 1. The large numbers at the top indicate the expected concentration of the solution consisting of at least one chemical substance normalized to 1 (note: 10°=1). For example, the fluid flow exiting through the outlet of the first generation channel contains 100% of solution, and the fluid flow exiting through the outlet of the second generation channel contains 10% of the solution.

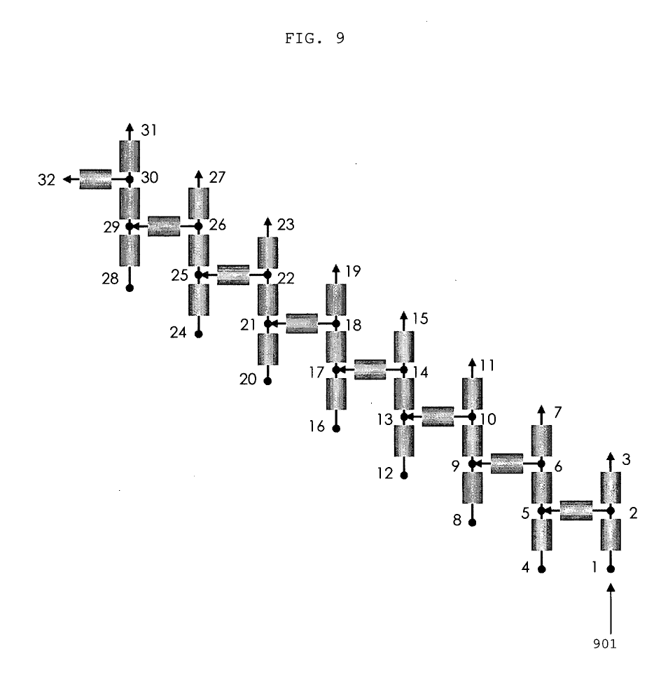

FIG. 9 corresponds to FIG. 8, and shows the model of the generator and the channel segments/channels. The resistances of the channels sections are estimated in such a way that this logarithmic concentration distribution is realized. The detailed calculation of the resistance of each segment/channel will be described later. The numbers in FIG. 9 indicate the nodes for inlet, outlet and channel junctions. For example, the channel lying between node 1 and 3 is the first generation channel with an inlet from node 1 and an outlet from node 3. The resistance of a channel segment is denoted as Rᵢⱼ, where i and j are nodes.

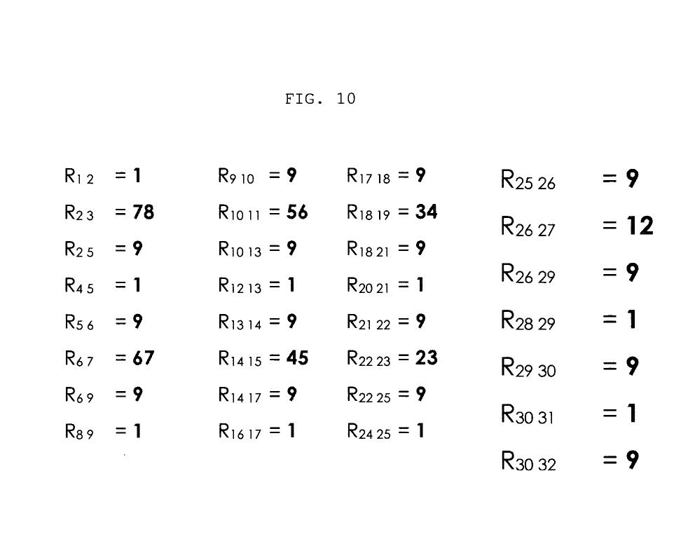

FIG. 10 shows the relative values of the channels' resistances of the logarithmic concentration gradient generator shown in FIG. 9.

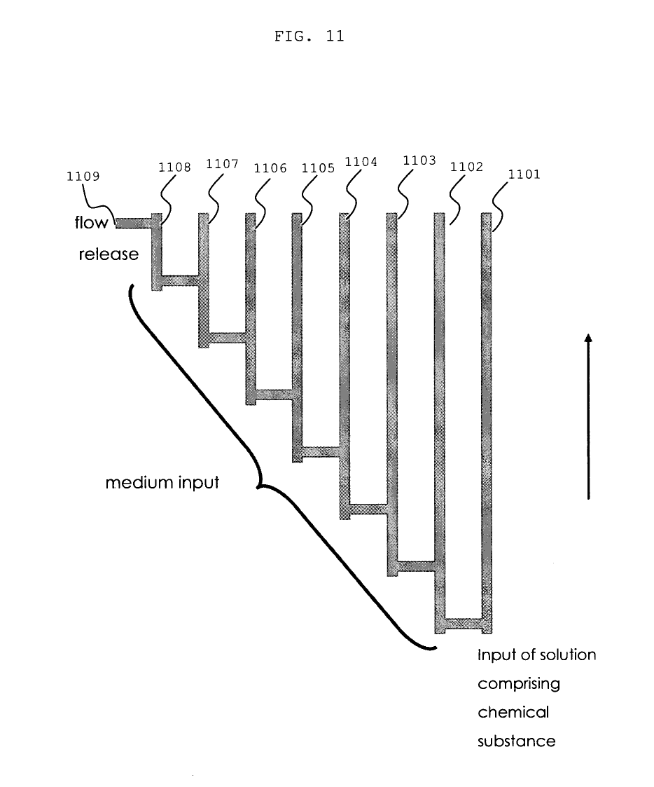

FIG. 11 corresponds to FIGS. 8 and 9, and shows the schematics of logarithmic concentration generator. The lengths of the channel sections represent the relative resistances. The solution consisting of at least one chemical substance enters into the first generation channel 1101, and the medium enters into the second generation channel 1102—eighth generation channel 1108. The flow release through the eighth connection channel 1109 is to compensate for the flow velocities, so that all the channels 1101-1108 have the fluid flow exiting from each outlet at the same flow rate. The flow rate at the inlets and outlets has been described in FIG. 8. The arrow indicates the flow direction.

In one example, an apparatus for gradient generation is provided. The apparatus comprises a first generation having a first generation channel, the first generation channel having an inlet, an outlet, and a connection node located in between the inlet and the outlet of the first generation channel. For example, referring to FIG. 9, the channel lying between nodes 1 and 3 may be the first generation channel, the first generation channel having an inlet 1, an outlet 3, and a connection node 2 located between the inlet 1 and the outlet 3. In one example, the apparatus further comprises a first connection channel having an inlet and an outlet, wherein the inlet of the connection channel is connected to the first generation channel at the connection node of the first generation channel. For example, referring to FIG. 9, the apparatus further comprises a first connection channel lying between nodes 2 and 5, the first connection channel having an inlet 2, and an outlet 5, wherein the inlet 2 of the connection channel is connected to the first generation channel at the connection node 2 of the first generation channel. In one example, the apparatus further comprises a second generation having a second generation channel, the second generation channel having an inlet, an outlet, and a first connection node located in between the inlet and the outlet of the second generation channel, wherein the first connection node of the second generation channel is connected to the first connection channel at the outlet of the first connection channel. For example, referring to FIG. 9, the apparatus further comprises a second generation having a second generation channel lying between the nodes 4 and 7, the second generation channel having an inlet 4, an outlet 7, and a first connection node 5 located in between the inlet 4 and the outlet 7 of the second generation channel, wherein the first connection node 5 of the second generation channel is connected to the first connection channel at the outlet 5 of the first connection channel.

In one example, for the logarithmic concentration gradient generator, the term “generation” may refer to the level that the concentration of inlet solution is diluted. For example, the first generation channel lying between the nodes 1 and 3 as indicated in FIG. 9 provides an outlet solution having the same concentration with the inlet solution 901. The second generation channel lying between the nodes 4 and 7 as indicated in FIG. 9 provides an outlet solution having a concentration of 10⁻¹ of the inlet solution 901, and the third generation channel lying between nodes 8 and 11 provides an outlet solution having a concentration of 10⁻² of the inlet solution 901, and so on.

In one example, the second generation channel may further comprise a second connection node located between the first connection node and the outlet of the second generation channel, the second connection node being connected to a second connection channel at an inlet of the second connection channel, wherein the second connection channel has an inlet and an outlet. For example, referring to FIG. 9, the second generation channel lying between the nodes 4 and 7 further comprises a second connection node 6 located between the first connection node 5 and the outlet 7 of the second generation channel, the second connection node 6 being connected to a second connection channel lying between the nodes 6 and 9 at an inlet 6 of the second connection channel, wherein the second connection channel has an inlet 6 and an outlet 9.

In one example, the apparatus for gradient generation may comprise a number of n generations, wherein n is any integer value that is larger than 1, and wherein each i^{th} (i=1 . . . n) generation has a generation channel, and a connection channel, wherein each generation channel has an inlet and an outlet, and wherein each connection channel has an inlet and an outlet. For example, referring to FIG. 9, the apparatus comprises 8 generations, and each generation has a generation channel and a connection channel. For example, the first generation comprises a generation channel lying between the nodes 1 and 3, and a connection channel lying between the nodes 2 and 5, wherein the first generation channel lying between the nodes 1 and 3 has an inlet 1 and an outlet 3, and wherein the first connection channel lying between the nodes 2 and 5 has an inlet 2 and an outlet 5.

In one example, for any generation channel that is not the first generation channel, each i^{th} generation channel may have a first connection node located in between the inlet and the outlet of the i^{th} generation channel, and a second connection node located in between the first connection node and the outlet of the i^{th} generation channel. Referring to FIG. 9, when taking the eighth generation channel as an example, the eighth generation channel lying between the nodes 28 and 31 has a first connection node 29 located in between the inlet 28 and the outlet 31 of the eighth generation channel, and a second connection node 30 located in between the first connection node 29 and the outlet 31 of the eighth generation channel.

In one example, the first connection node of the i^{th} generation channel is connected to a (i−1)^{th} connection channel at the outlet of the (i−1)^{th} connection channel, and the second connection node of the i^{th} generation channel is connected to an i^{th} connection channel at the inlet of the i^{th} connection channel. For example, referring to FIG. 9, the first connection node 29 of the eighth generation channel lying between the nodes 28 and 31 is connected to a seventh connection channel lying between the nodes 26 and 29 at the outlet 29 of the seventh connection channel, and the second connection node 30 of the eighth generation channel is connected to an eighth connection channel lying between the nodes 30 and 32 at the inlet 30 of the eighth connection channel.

In one example, fluid flow resistance of a channel is varied differently by changing the length or height or width of the channels.

In one example, the gradient generation channel is a logarithmic gradient generation apparatus.

In one example, the solution consisting of at least one chemical substance enters the first generation channel, and the medium enters other generation channels. In one example, the relative inlet flow rate at the first generation channel may be 10, and the relative inlet flow rate at the other generation channels may be 9. For example, referring to FIG. 9, the solution comprising a chemical substance enters the first generation channel lying between the nodes 1 and 3, and the medium enters the generation channels lying between nodes 4 to 7, 8 to 11, 12 to 15, 16 to 19, 20 to 23, 24 to 27, and 28 to 31. In one example, the relative inlet flow rate at the first generation channel lying between the nodes 1 and 3 is 10, and the relative inlet flow rate at the other generation channels lying between the nodes 4 to 7, 8 to 11, 12 to 15, 16 to 19, 20 to 23, 24 to 27, and 28 to 31 is 9. The flow rate at each generation channel and connection channel is also labeled in FIG. 8.

In one example, referring to FIG. 9, the flow rate (v) V_{2 to 3}=9 and V_{2 to 5}=1. In one example, 1/10 of the flow is redirected to the next channel via V_{2 to 5}. That means the flow rates at all the outlets is 9.

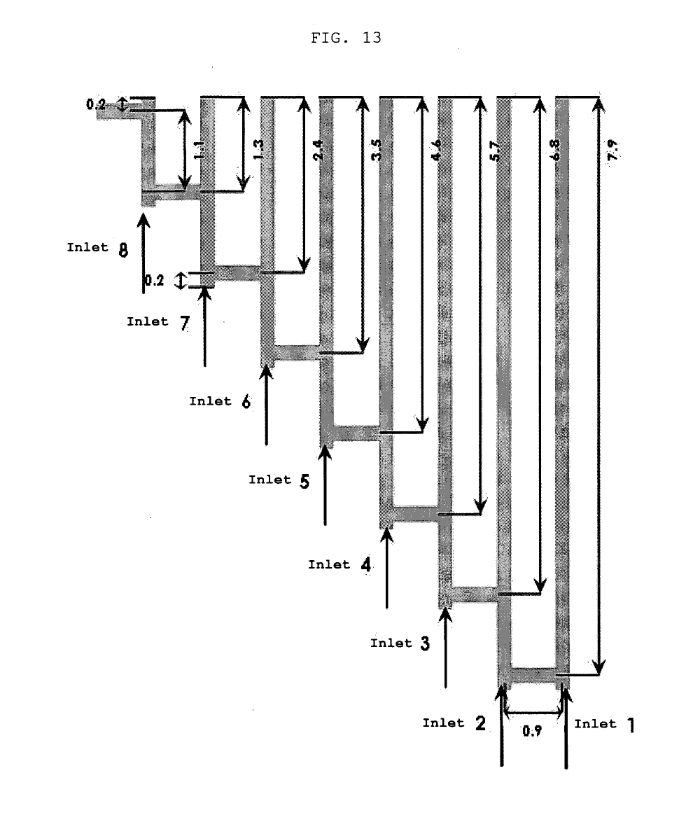

In another example, referring to FIG. 13, only inlet 1 (node 1) v=10, all the other inlets have v=9. All the vertical channel section between the two horizontal channel sections (two connection channels) may have v=10. That means (referring to FIG. 9) V_{5 to 6}=V_{4 to 5}+V_{2 to 5}=10. But V_{6 to 7}=V_{5 to 6}_{^{−}}=V_{6 to 9}=9, etc. The remaining sections are similarly setup. For the last node V_{29 to 30}=10, but the outlet V_{30 to 31}=9 so that the fluid flow exiting through all outlets has the same flow rate. Therefore, the channel lying between nodes 30 and 32 is provided, so V_{30 to 32}=1. This functions as an “overflow” to balance the flow rates of the fluid flow exiting from different outlets. As used herein, V_{i to j} represents the fluid flow rate in the channel lying between nodes i and j.

The values of the resistances are calculated from the fluidic Ohm's and Kirchoff's law, by assuming a few initial values. A detailed description illustrating how the calculation is carried out is provided further below. If one of the resistances is changed, the whole flow distribution can be altered. For example, changing R_{2 to 3} would lead to different flow rates and distributions of the fluid flow exiting through different outlets. As used herein and after, R_{i to j} represents the fluid flow resistance of the channel lying between the nodes i and j as indicated in FIG. 9.

In one example, the apparatus for logarithmic gradient generation satisfies R_{Cn}=9×R_{Gn3}, wherein R_{Cn} is the fluid flow resistance of the n^{th} connection channel, and R_{Gn3} is the fluid flow resistance between the second connection node and the outlet of the n^{th} generation channel. For example, referring to FIG. 9, the apparatus for logarithmic generation satisfies R_{C8}=9×R_{G83}, wherein R_{C8} is the fluid flow resistance of the eighth connection channel lying between the nodes 30 and 32, and R_{G83} is the fluid flow resistance between the second connection node 30 and the outlet 31 of the eighth generation channel.

In a further example, the apparatus for gradient generation satisfies R_{Gi3}=(R_{Ci}+10×R_{G(i+1)2}+9×R_{G(i+1)3})/9, (i=1 . . . n−1), wherein R_{Gi3} is the fluid flow resistance between the second connection node and the outlet of i^{th} generation channel, R_{Ci} is the fluid flow resistance of i^{th} connection channel, R_{G(i+1)2} is the fluid flow resistance between the first connection node and the second connection node of the (i+1)^{th} generation channel, and R_{G(i+1)3} is the fluid flow resistance between the second connection node and the outlet of the (i+1)^{th} generation channel. Referring to FIG. 9, take i to be 7 as an example, the apparatus for gradient generation satisfies R_{G73}=(R_{C7}+10×R_{G82}+9×R_{G83})/9 wherein R_{G73} is the fluid flow resistance between the second connection node 26 and the outlet 27 of seventh generation channel lying between the nodes 24 and 27, R_{C7} is the fluid flow resistance of seventh connection channel lying between the nodes 26 and 29, R_{G82} is the fluid flow resistance between the first connection node 29 and the second connection node 30 of the eighth generation channel lying between the nodes 28 and 31, and R_{G83} is the fluid flow resistance between the second connection node 30 and the outlet 31 of the eighth generation channel.

The calculation of the resistance values for the channels of the logarithmic concentration gradient generator are illustrated in more detail further below.

For a logarithmic gradient generator with a number of n gradient generations, in order to achieve that at the second connection node of the n^{th} generation channel, 10 percent of the fluid flow enters the n^{th} connection channel, the following formula should be satisfied (Ohm's law):

u_{Cn}×R_{Cn}=u_{Gn3}×R_{Gn3}

wherein R_{Cn} is the fluid flow resistance of the n^{th} connection channel, and R_{Gn3} is the fluid flow resistance between the second connection node and the outlet of the n^{th} generation channel. As 10 percent of the fluid flow enters the n^{th} connection channel, we have

U_{Cn}×9=u_{Gn3}

From the above two equations, we have:

R_{Cn}=9×R_{Gn3}

As an illustration, referring to FIGS. 9 and 10, if the relative resistance R_{30 to 31} (R_{Gn3}) is assumed to be 1, then the relative resistance R_{30 to 31} (R_{Cn}) would be 9, namely 9 times R_{30 to 31}.

Further, for a i^{th} (i=1 . . . n−1) gradient generation channel, according to the Ohm's law, the following formula may be satisfied:

R_{Gi3}×u_{Gi3}=R_{Ci}×u_{Ci}+R_{G(i+1)2}×u_{G(i+1})2+R_{G(i+1)3}×u_{G(i+1)3}

Wherein R_{Gi3} is the fluid flow resistance between the second connection node and the outlet of i^{th} generation channel, R_{Ci} is the fluid flow resistance of i^{th} connection channel, R_{G(i+1)/2} is the fluid flow resistance between the first connection node and the second connection node of the (i+1)^{th} generation channel, and R_{G(i+1)3} is the fluid flow resistance between the second connection node and the outlet of the (i+1)^{th} generation channel, u_{Gi3} is the fluid flow rate in the channel between the second connection node and the outlet of i^{th} generation channel, u_{Ci} is the fluid flow rate in the ith connection channel, u_{G(i+1)2} is the fluid flow rate between the first connection node and the second connection node of the (i+1)^{th} generation channel, and u_{G(i+1)3} is the fluid flow rate between the second connection node and the outlet of the (i+1)^{th} generation ration channel.

For the logarithmic gradient generator, according to the Kirchhoff's law, the relations of the fluid flow rate in different channels satisfy:

u_{Gi3}=9×u_{Ci}=u_{G(i+1)3}; and u_{G(i+1)2}=10×u_{Ci}

Thus, from the above three equations, we have:

R_{Gi3}=(R_{Ci}+10×R_{G(i+1)2}+9×R_{G(i+1)3})/9

As an illustration, referring to FIGS. 9 and 10, if the relative resistance R_{30 to 31} (R_{G(i+1)3}) is 1, then if we assume the relative resistance of R_{29 to 30} (R_{G(i+1)2}) and the relative resistance of R_{26 to 29} (R_{Ci}) to be 9, from the above equation we will have the relative resistance

R_{26 to 27}(R_{Gi3})=(R_{26 to 29}+10×R_{29 to 30}+9×R_{30 to 31})/9=12

It should be noted that the relative resistance R_{29 to 30} (R_{G(i+1)2}) and R_{26 to 29} (R_{Ci}) in this example can be also assumed to have other values. For example, if we assume R_{29 to 30}(R_{G(i+1)2}) to be 3 and R_{26 to 29} (R_{Ci}) to be 6, we will have the relative resistance

R_{26 to 27}(R_{Gi3})=(R_{26 to 29}+10×R_{29 to 30}+9×R_{30 to 31})/9=5

As can be seen from the example given in the previous paragraphs, the resistances are calculated from Ohm's and Kirchhoff's laws. A few values may be assumed (such as R_{30 to 31} (R_{G(i+1)3}), R_{26 to 29} (R_{Ci}) and R_{29 to 30} (R_{G(i+1)2})) as to calculate all the other resistances. The thus obtained resistance values are only relative, not absolute. That means that, referring to FIG. 9 and FIG. 10, when R_{1 to 2} is set to be 2, then, for example, R_{10 to 11} may be 102. These ratios of resistances give the logarithmic flow distribution. If the ratios would be different, it would result in another distribution. In this sense the architecture of the layout is fixed.

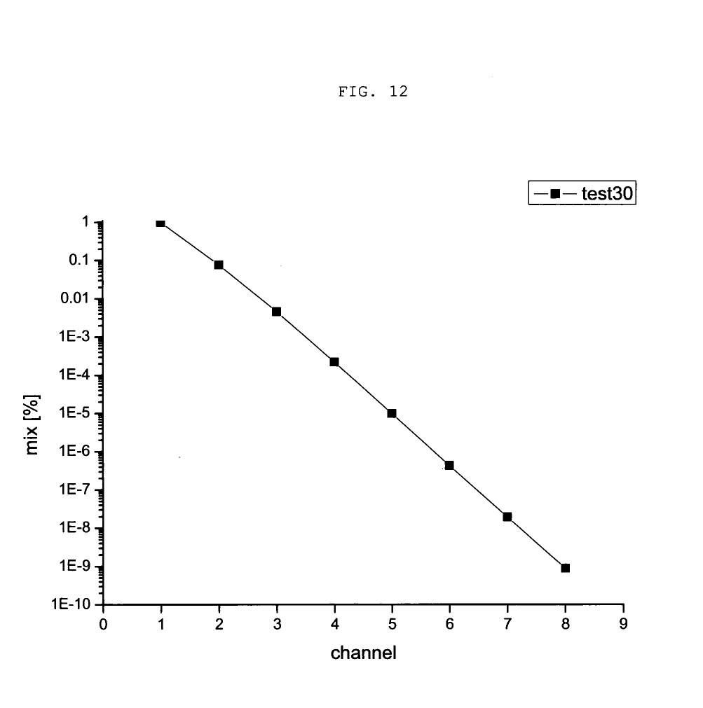

Previous computer experiments show an excellent logarithmic distribution of the solution, compared to medium (FIG. 12). FIG. 12 shows the outlet solution concentrations at the eight outlets of the logarithmic gradient generator, as shown in FIGS. 8, 9 and 11. The channel numbers 1-8 in the horizontal axis in FIG. 12 correspond to channels 801-808 (FIG. 8). The mix [%] in FIG. 12 refers to the concentration of solution at the outlets of channels 801-808. For example, channel 1 in FIG. 12 shows a mix [%] of 1×100%, meaning that the fluid flow exits the device through the outlet 811 of the corresponding channel 801 (FIG. 8) has a solution concentration of 100%, i.e. it is identical to the original solution and is not diluted. For another example, referring to FIG. 12, channel 3 shows a mix [%] of 0.01×100%, meaning that the fluid flow exits the device through the outlet of the corresponding channel 803 (FIG. 8) has a concentration of a chemical substance in the solution 1%, i.e. it is identical to 10⁻² concentration of the original solution and is diluted.

FIG. 13 corresponds to FIG. 11, wherein the dimensions of the channels of a logarithmic concentration gradient generator as shown in FIG. 11 are illustrated. In the example shown in FIG. 13, the flow velocity was set at: inlet 1=10×10⁻² μm/s and other inlets were 9×10⁻² μm/s. In one example, the inlet flow rate is in the range of 10⁻² to 10 μm/s.

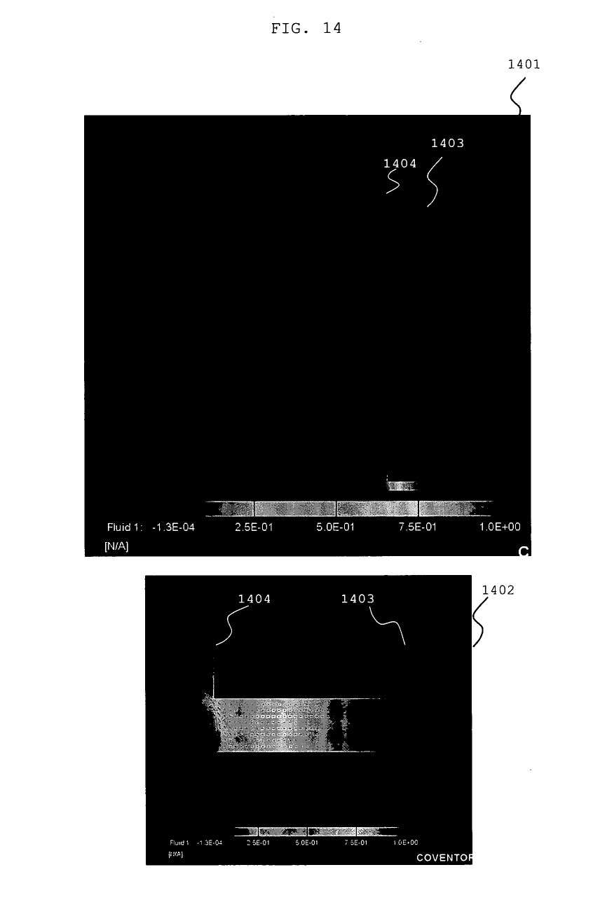

FIG. 14 illustrates the simulation results of the logarithmic concentration gradient generator as shown in FIG. 11 using the parameters (dimensions of the channels) illustrated in FIG. 13. 1401 (FIG. 14) shows the mixing of the two flows. The insert 1402 on the right gives a magnification of the 2 first inlets of the first generation channel 1403 and the second generation channel 1404. For example, the channel 1403 in FIG. 14 corresponds to the channel 1101 in FIG. 11, and the channel 1404 in FIG. 14 corresponds to the channel 1102 in FIG. 11.

In one example, a gradient generator can be connected to a plurality of biological material cultivation chambers.

Different kinds of biological material cultivation chambers are known in the art, such as the one described in WO 2007/008609.

In general, a biological material cultivation chamber is dimensioned to retain a biological material in the cultivation chamber. In one example, such a cultivation chamber has a circumferential wall, wherein the circumferential wall has at least one inlet and at least one outlet in order to allow flow of a cultivation medium through the cultivation chamber. The biological material which is retained in the cultivation chamber can include, but is not limited to, a tumor spheroid, an organism in an embryonic stage, eukaryotic cells, or prokaryotic cells. In one example, each outlet of a gradient generator provides a liquid stream having, e.g., a substance A at a certain concentration. The connection between an outlet of the gradient generator and the inlet of a cultivation chamber can be a channel having the same structure and dimensions as the channels of the concentration gradient generator. It is also possible that the width of a channel which is fluidly connecting an outlet of the concentration gradient generator and an inlet of a cultivation chamber has a different width. Increasing the width of the connecting channel relative to the width of the channel of the concentration gradient generator can reduce the speed of the liquid inside the channel. Decreasing the width of the connecting channel relative to the width of the channel of the concentration gradient generator can increase the speed of the liquid inside the channel.

In one example, an outlet of the concentration gradient generator splits up into several outlet channels. In one example, the several outlet channels are all feeding the same liquid stream into a same or a different cultivation chamber, i.e. one outlet of a concentration gradient generator is fluidly connected with more than one cultivation chamber, namely with at least two, three, four, five, six, seven, eight or even more (PCT/SG2008/000318).

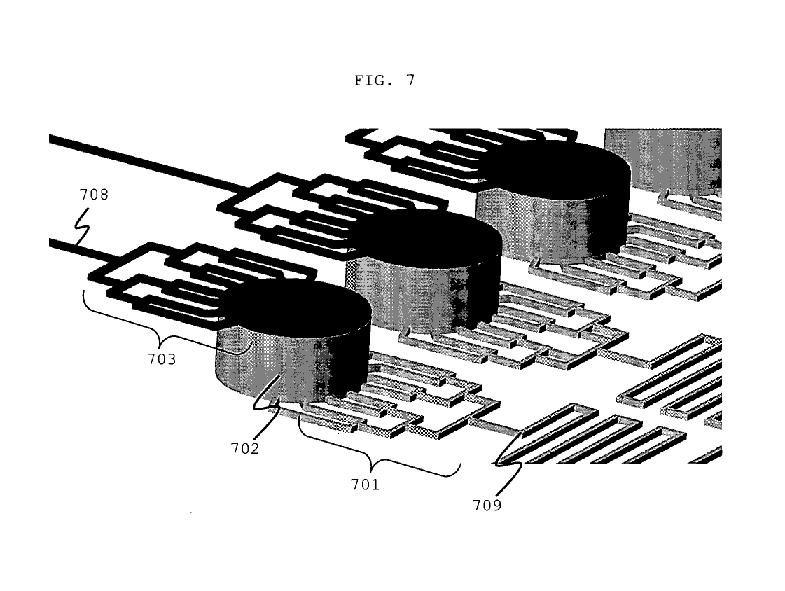

For example, FIG. 7 shows that an outlet 709 of a concentration gradient generation channel divides into 8 outlets 701 and the 8 outlet of the gradient generator are fluidly connected to inlets of a single biological material cultivation chamber 702. In one example, a cultivation chamber can also comprise a plurality of outlets 703 as shown for example in FIG. 7. The 8 outlets 703 of the cultivation chamber 702 can merge into one outlet channel 708.

The cultivation chamber can in general be of any shape as long as it is dimensioned to retain a biological material in the cultivation chamber. The cultivation chamber should be dimensioned in order to retain the biological material in a position that allows for example optical analysis of the biological material retained in the cultivation chamber. The shape (seen in cross section) of the cultivation chamber can be for example polygonal or a trapezoid. In another example, the shape (seen in cross section) of the cultivation chamber can be a semi-circular, or circular cross section. Cultivation chambers of other polygonal cross-sections, such as a triangular, square, rectangular, pentagonal, hexagonal, octagonal, oblong, ellipsoidal etc. are also possible.

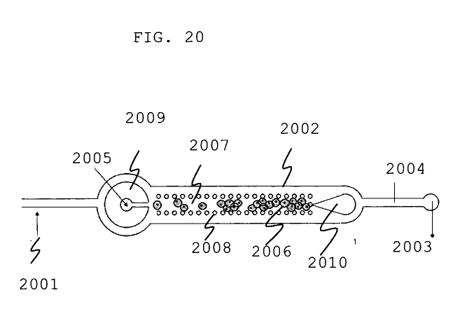

FIG. 20 shows another example of a biological material cultivation chamber (PCT/SG2008/000293). The second inlet 2001 feeding line feeds the channel 2002 with cultivation medium which enters the channel through the second inlet and exits the channel through the outlet 2003. 2004 shows an additional exit channel fluidly connecting the outlet with the channel. Also shown is the first inlet 2005 through which the biological material 2006 is introduced into the compartment 2007 of the channel 2002. The compartment 2007 is defined by partitioning elements 2008. Also shown are the medium flow separator 2009 and 2010. It should be noted that the cultivation chamber may comprise more than one compartment.

The substrate for manufacturing a microfluidic continuous flow device including cultivation chambers and a concentration gradient generator may be molded using any type of material which can be made into a microfluidic continuous flow device of the invention. In one example the material is chosen to allow observation of cells. Such materials include polymers, glass, silicone or certain types of metal.

In one embodiment, the material for forming the substrate is a biocompatible material. A biocompatible material includes, but is not limited to, glass, silicon and a polymerisable material. The polymerisable material includes, but is not limited to, monomers or oligomeric building blocks (i.e. every suitable precursor molecule) of polycarbonate, polyacrylic, polyoxymethylene, polyamide, polybutylenterephthalate, polyphenylenether, polydimethylsiloxane (PDMS), mylar, polyurethane, polyvinylidene fluoride (PVDF), flourosilicone or combinations and mixtures thereof. In some examples, the biocompatible material comprises PVDF and/or PDMS. Advantages of PVDF and PDMS are their cheap price and superior biocompatibility. Furthermore, as they are transparent, they conveniently allow direct morphological observation of the biological material under an observation device, e.g. a microscope, to be carried out. In one example the microfluidic continuous flow device is made of poly(-dimethylsiloxane) (PDMS).

Furthermore, the microfluidic continuous flow device including cultivation chambers and a concentration gradient generator can comprise a cover and/or bottom layer forming the top and/or bottom of the cultivation chamber. The cover layer can have any suitable optical transparency. A fully opaque cover or one which is transparent, or one which is made of a translucent material (thereby permitting the transmission of a certain amount of light) may be used. In a further example, the top and/or bottom layer may comprise a biocompatible material that is transparent or at least substantially translucent in order that the device is compatible for use with optical microscopes which can provide a backlight that can be directed through a cultivation chamber of the microfluidic continuous flow device in order to provide a bright view of the processes occurring in the cultivation chamber during its use.

Another aspect of the invention concerns the fabrication of the above described microfluidic continuous flow devices. The template for creating the device of the invention can be fabricated according to any technique known in the art, such as photolithography, etching, electron-beam lithography, laser ablation, hot embossing, etc. depending on the material used. For example, when fabricating devices using Si templates in microscale and nanoscale, it is possible to use laser ablation, etching or hot embossing, and electron-beam lithography respectively. Templates can also be manufactured using epoxy based negative resists with high functionality, high optical transparency and sensitivity to near UV radiation, such as photoresists of the SU-8 series from MicroChem Corp. (Newton, Mass., US). The above techniques are known in the area of microelectronics and microfabrication. After creating the template the microfluidic continuous flow device is then created by replica molding of, for example, poly(-dimethylsiloxane) (PDMS) on the template. In one example, the silicon templates can for example be fabricated by standard deep reactive ion etching (DRIE) process.

The biological material which is retained in a cultivation chamber can include, but is not limited to tumor spheroids, an organism in an embryonic stage, prokaryotic cells, eukaryotic cells, cell aggregates from the aforementioned group of cells and mixtures thereof.

The organism in an embryonic stage includes, but is not limited to amphibian eggs, fish eggs, insect eggs and mammalian eggs. Examples for fish eggs include, but are not limited to an egg of a zebrafish (Danio rerio), an egg of a medaka (Oryzias latipes), an egg of a giant danio (Devario aequipinnatus), and an egg of a fish from the family Tetraodontidae (puffer fish). An example for an amphibian egg can include, but is not limited to toad eggs, frog eggs, an egg of Caenorhabditis elegans (C. elegans) and salamander eggs. Examples for an insect egg include, but are not limited to an egg from a fruit fly (Drosphila melanogaster). In some examples the organism can be a mammalian embryo except embryos of humans. It is also possible to use Caenorhabditis elegans (C. elegans), prokaryotic or eukaryotic cells, for cultivation in the cultivation chamber of the microfluidic continuous flow device of the present invention. C. elegans is about 1 mm long and is used as model organism for studying cell differentiation.

The group of prokaryotic cells includes, but is not limited to archaea, green bacteria, gram-positive bacteria, deinococcus, spirochaeta, planctomycetes, Chlamydia, purple bacteria including the group of gram-negative bacteria, cyanobacteria and flavobacteria. (Systematic classification is based on the 16S-rRNA comparison as referred to by Hans G. Schleger, 1992, Allgemeine Mikrobiologie, 7^{th} edition, page 93). Examples for eukaryotic cells include, but are not limited to mammalian cells, ciliate cells, fungi, plants, flagellates and microsporidias.

Examples for mammalian cell lines or primary cells can include, but are not limited to bone marrow stroma cells, calvarial osteoblasts, Langerhans cells, hepatocytes, chondrocytes, sinusoidal endothelial cells, cardiomyocytes, glioma cells (from brain), dermal fibroblasts, keratinocytes, oligodendrocytes, hematopoetic stem cells, T-lymphocytes, macrophages and neutrophils. Primary hepatocytes or primary kidney cells can also be used. Stem cells, cancerous cells as well as non cancerous cells can also be used as biological material. Some examples of cell lines which can be used are primary adipocytes, A549 lung cells (carcinomic human alveolar basal epithelial cells), proximal tubular human kidney HK-2 cells and the human hepatocellular carcinoma cell line HepG2/C3A (liver). Besides cells of human origin, cells of cat, cow, rat, mouse, sheep, monkey, pig, horse, dog and amphibian origin and insect cells can also be used. Of particular interest are cells or cell lines which can be used for drug tests.

This platform allows for the creation of specific microenvironments in the cultivation chambers in which, for example, a biological material resides. A biological material can be treated with small molecules and drugs for example for high-throughput analysis and for the identification and validation of drugs. High-throughput methodologies include, but are not limited to, phenotype-based visualization, transcript studies using low-density DNA microarrays or proteomic analysis. In case of fish embryos, the embryonic development, ex utero, of for example, medaka and zebrafish is 9 to 11 and 2 days, respectively, making those organisms very suitable for the cultivation in the cultivation chamber of the microfluidic continuous flow device described herein. Due to their small egg size (about 700 μm to about 1000 μm) they are also particularly suitable for analysis in a microfluidic continuous flow device described herein. To follow the development of these fishes it is possible to use transgenic animals. For example, by using a reporter protein (e.g., green fluorescence protein GFP) it is possible to follow the development effect of certain drugs on these organisms in the cultivation chamber.

Tumor spheroids are aggregates made up of tumor cells, or cell lines, which can also be located into a cultivation chamber. The tumor spheroids can be selected from every kind of cancer tumor. Such a cancer can include, but is not limited to a basal cell carcinoma, bladder cancer, bone cancer, brain cancer, CNS cancer, breast cancer, cervical cancer, colon cancer, rectum cancer, connective tissue. cancer, esophageal cancer, eye cancer, kidney cancer, larynx cancer, liver cancer, lung cancer, Hodgkin's lymphom, non-Hodgkin's lymphom, melanoma, myeloma, leukemia, oral cavity cancer, ovarian cancer, pancreatic cancer, prostate cancer, rhabdomyosarcoma, skin cancer, stomach cancer, testicular cancer, neoplasia or uterine cancer.

The chemical substance can be any molecule which has or is suspected to have an effect on the biological material retained in the cultivation chamber. Such a chemical substance can include, but is not limited to a pharmaceutical composition, a compound which is or which is suspected to be necessary for the cultivation of the biological material and which is initially not comprised in the cultivation medium; a compound which is or which is suspected to be necessary for the metabolism of the biological material and which is initially not comprised in the cultivation medium; a compound or composition which is or which is suspected to be teratogenic, cancerogenic, mutagenic, psychogenic or toxic, or mixtures thereof. Such a chemical substance can also be a gaseous substance.

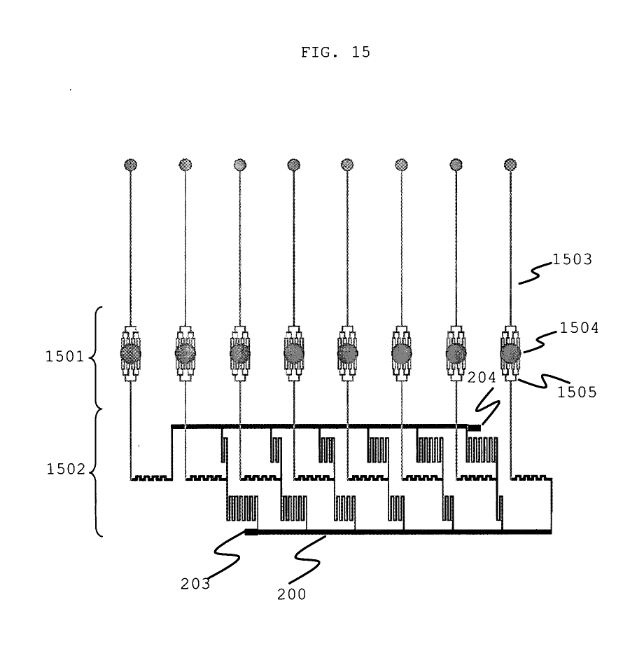

In one example, the outlets of a concentration gradient generator are fluidly connected to the inlets of a plurality of biological material cultivation chambers. Referring to FIG. 15, a linear gradient generator 200 as shown in FIG. 2 is provided. Each outlet of the third generation channels of the linear gradient generator 200 is fluidly connected to an inlet 1505 a biological material cultivation chamber 1504, wherein a biological material is located, and which has an outlet 1503. Thus, the medium or the solution or the mixture of the medium and the solution from each outlet of the third generation channels of the linear gradient generator 200 enters a different biological material cultivation chamber 1504.

In one example, connection of a logarithmic gradient generator as shown in FIG. 11 with a plurality of biological material cultivation chambers can be carried out in the same manner as connecting a linear gradient generator 200 with a plurality of biological material cultivation chambers 1504 as shown in FIG. 15. For example, referring to FIG. 11, each outlet (1101-1108) of the generation channels of the logarithmic gradient generator can be fluidly connected with an inlet of a biological material cultivation chamber.

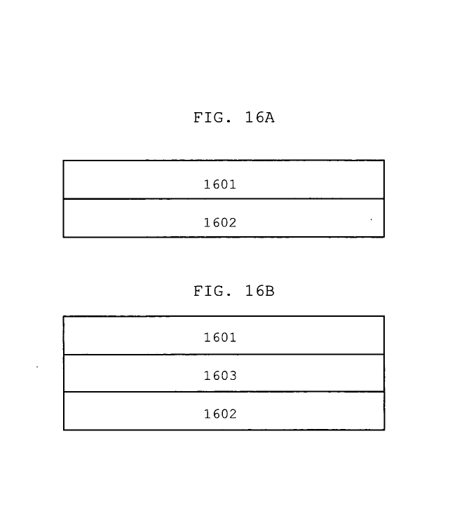

In one example, referring to FIG. 16A, a kit is provided which comprises a first module 1601. In one example, the first module 1601 comprises a linear gradient generator, i.e. as shown in FIG. 2. However, it should be noted that the linear gradient generator is not limited to the one shown in FIG. 2. For example, the linear gradient generator may have different number of outlets of the third generation channels. For example, the channels/segments of the linear gradient generator may have different relative resistance values from the ones shown in FIG. 2. For example, the linear gradient generator may have only one control channel but not two.

In one example, the kit further comprises a second module 1602 comprising a plurality of biological material cultivation chambers. The outlets of the third generation channels of the linear gradient generator in the first module 1601 may be connected to inlets of the plurality of biological material cultivation chambers in the second module.

In another example, each outlet for a concentration of a gradient generator in the first module 1601 may split up into a plurality of outputs. In one example, each of the plurality of outputs for a concentration may be connected with an inlet of a biological material cultivation chamber.

In one example, referring to FIG. 16B, the kit can further comprise a third module 1603 located between the first module 1601 and the second module 1602, wherein the third module serves as a channel multiplier and provides channels which fluidly connect the outlets of the third generation channels of the linear gradient generator with inlets of the plurality of biological material cultivation chambers.

In one example, each channel provided by the third module 1603 has at least one inlet and at least one outlet. In one example, the outlet or outlets for a concentration of each third generation channel of the linear gradient generator in the first module 1601 is fluidly connected to at least one inlet of a channel of the third module. The at least one outlet of the channel of the third module is connected to an inlet of at least one biological material cultivation chamber.

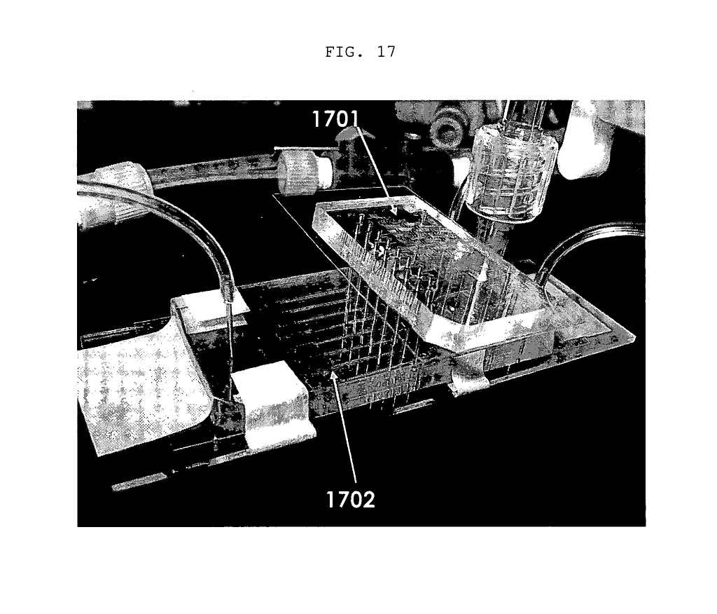

For example, FIG. 17 illustrates an experimental photo of a kit comprising a first module which has a gradient generator 1701, and a second module which has a plurality of biological material cultivation chambers 1702. Each outlet for a concentration of the gradient generator 1701 in the first module splits up into two outlets. The outlets for each concentration are fluidly connected to inlets of a biological material cultivation chamber 1702 in the second module.

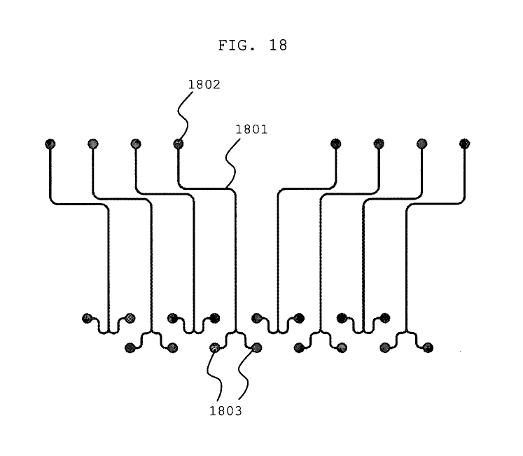

In another example, a channel in the third module 1603 has at least one inlet and at least one outlet. For example, referring to FIG. 18, channel 1801 of a third module has one inlet 1802 and two outlets 1803. Thus, this third module divides the incoming solutions from the first module into two separate outlets which can then be connected each to a different cultivation chamber.

It is noted however that the number of both inlets and outlets of a channel is not limited to the example shown in FIG. 18. For example, a channel in the third module may have any number of inlets or outlets besides 2. In one example, referring to FIG. 18, the inlet 1802 of the channel 1801 can be fluidly connected to an outlet of a gradient generator, and the outlets 1803 of the channel 1801 can be connected to inlets of a biological material cultivation chamber.

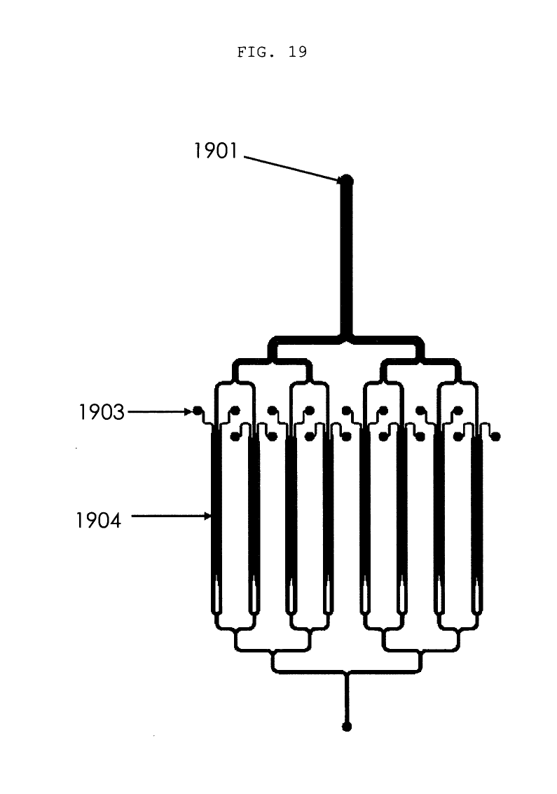

In another example, shown in FIG. 19, a microfluidic flow device is illustrated which is comprised in a second module. The device comprises a cell reservoir 1901 for providing a biological material a plurality of biological material cultivation chambers 1904, each having two inlets which are to be connected fluidly with outlets of a channel in the third module. For example, the outlets 1803 in FIG. 18 can be connected to inlets 1903 of the biological material cultivation chamber 1904 shown in FIG. 19. One example of such a biological material cultivation chamber 1904 is illustrated in more detail in FIG. 20.

In one example, the first module 1601 in FIGS. 16A and 16B comprises a logarithmic gradient generator, for example, the one as shown in FIG. 11. However, it should be noted that the logarithmic gradient generator is not limited to the example shown in FIG. 11. For example, the number of generation channels of the logarithmic gradient generation is not limited to be the same as shown in FIG. 11.

In another example, the outlets of the generation channels of the logarithmic gradient generator in the first module 1601 are connected to inlets of the plurality of biological material cultivation chambers in the second module 1602 as shown in FIG. 16A.

It is also possible that each outlet of a concentration of a generation channel of the logarithmic gradient generator splits up into a plurality of outlets. The outlets for a concentration of the gradient generator may be directly connected to inlets of at least one biological material cultivation chambers.

In one example, referring to FIG. 16B, the third module 1603 provides channels which fluidly connect the outlets of the generation channels of the logarithmic gradient generator and inlets of the plurality of biological material cultivation chambers.

In another example, the outlet or outlets of each generation channel of the logarithmic gradient generator in the first module 1601 can be connected to an inlet or inlets of a channel of the third module 1603.

It is also possible that the first module shown in FIGS. 16A and 16B may further comprise one or more gradient generators, wherein outlets of the one or more gradient generators are fluidly connected to inlets of the plurality of biological material cultivation chambers as shown in FIG. 16A or the inlets of the channels in the third module 1603 as shown in FIG. 16B.

In one example, the first module 1601 may comprise both the linear gradient generator, for example as shown in FIG. 2, and the logarithmic gradient generator, for example as shown in FIG. 11. In another example, the first module 1601 may further comprise one or more gradient generators which are different from the linear or logarithmic gradient generators described herein.

The present invention is further directed to a method of subjecting a biological material located in a cultivation chamber to a test substance. The method can comprise: providing a linear gradient generator such as the one described herein and a plurality of cultivation chambers which can retain a biological material. The method further comprises introducing a cultivation medium through an inlet into one of the two first generation channels of the linear gradient generator, and introducing a test substance through an inlet into the other first generation channel of the linear gradient generator, whereby the cultivation medium or the test substance or a mixture of the cultivation medium and the test substance is obtained at the outlet of each third generation channel of the linear gradient generator. Each of the mixtures or the cultivation medium or the test substance flows through at least one of the plurality of cultivation chambers.

In another aspect, the present invention refers to a method of subjecting a biological material located in a cultivation chamber to a test substance. The method comprises: providing a logarithmic gradient generator as described herein and a plurality of cultivation chambers which can each retain a biological material. The method further comprises introducing a test substance through an inlet into the first generation channel of the logarithmic gradient generator and introducing a cultivation medium through an inlet into other generation channels of the logarithmic gradient generator, whereby the test substance or a mixture of the cultivation medium and the test substance is obtained at the outlet or outlets of each generation channel of the logarithmic gradient generator. Each of the mixtures or the test substance flows through at least one of the plurality of cultivation chambers.

In another aspect, the present invention refers to a method of subjecting a biological material located in a cultivation chamber to a test substance, the method comprising: providing a linear gradient generator as described herein, a logarithmic gradient generator as described herein, and a plurality of cultivation chambers, each retaining the biological material. The method further comprises introducing a cultivation medium through an inlet into one of the two first generation channels of the linear gradient generator, and introducing a test substance through an inlet into the other first generation channel of the linear gradient generator, whereby the cultivation medium or the test substance or a mixture of the cultivation medium and the test substance is obtained at the outlet or outlets of each third generation channel of the linear gradient generator. Each of the mixtures or the cultivation medium or the test substance flows through at least one of the plurality of cultivation chambers. The method further comprises introducing a test substance through an inlet into the first generation channel of the logarithmic gradient generator and introducing a cultivation medium through an inlet into other generation channels of the logarithmic gradient generator, whereby the test substance or a mixture of the cultivation medium and the test substance is obtained at the outlet or outlets of each generation channel of the logarithmic gradient generator. Each of the mixtures or the test substance flows through at least one of the plurality of cultivation chambers which retains the biological material.

The method further comprises providing one or more gradient generators, introducing a cultivation medium and the test substance through inlets into the one or more gradient generators, whereby the cultivation medium or the test substance or a mixture of the cultivation medium and the test substance is obtained at the outlets of each outlet of the one or more gradient generators. Each of the mixtures or the cultivation medium or the test substance flow through at least one of the plurality of cultivation chambers which retains the biological material.

The above described microfluidic continuous flow devices of the linear gradient generator and the logarithmic gradient generator as well as the kit comprising gradient generator(s) and a biological material cultivation chamber can be used for any biological assays such as, but not limited to, high throughput drug screening assays with, wastewater and drinking water analysis assays, assays testing of the biological effect of at least one chemical substance. To name only a few examples, this at least one chemical substance may be a pharmaceutical compound or composition, a compound which is or which is suspected to be necessary for the cultivation of the biological material and which is initially not comprised in the cultivation medium; a compound which is or which is suspected to be necessary for the metabolism of the biological material and which is initially not comprised in the cultivation medium; a compound or composition which is or which is suspected to be teratogenic, cancerogenic, mutagenic, psychogenic, toxic; or mixtures thereof.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An apparatus for linear gradient generation comprising:
a first generation having a least two first generation channels, each first generation channel having an inlet;
a second generation having at least four second generation channels, each second generation channel having a inlet and an outlet, the inlet of each second generation channel being in communication with one of the at least two first generation channels, the outlet of each being in communication with the outlet of one of the other second generation channels, at a crossing point, wherein the inlet of the other second generation channel is in communication with another first generation channel;
a third generation having at least three third generation channels, each third generation channel having an inlet and an outlet;
at least a control channel being connected to one of the at least two first generation channels, the at least a control channel having an inlet and an outlet, wherein the inlet of the at least a control channel is connected with one of the at least two first generation channels, and the outlet of the at least a control channel is connected with an inlet of one of the at least three third generation channels;
wherein a crossing point between two second generation channels is in communication with an inlet of one of the at least three third generation channels;
wherein the dimensions of the second generation channels that are in communication with a same first generation channel are chosen such that the fluid flow resistances of the second generation channels vary linearly;
wherein the sum of fluid flow resistance of any two second generation channels that are in communication with each other is a predetermined value; and
where fluid flow resistance of the first generation channels are much less than the second generation channels.

2. The apparatus for linear gradient generation according to claim 1, wherein each of the at least third generation channel is of serpentine shape including multiple turns.

3. The apparatus for linear gradient generation according to claim 1, wherein the fluid flow resistance of second generation channels is be varied differently by changing the length of the channels.

4. The apparatus for linear gradient generation according to claim 1, wherein the fluid flow resistance of second generation channels is be varied differently by changing the height of the channels.

5. The apparatus for linear gradient generation according to claim 1, wherein the fluid flow resistance of second generation channels is be varied differently by changing the width of the channels.

6. The apparatus for linear gradient generation according to claim 1, wherein each outlet of the third generation channels divides in a plurality of outlets.

7. The apparatus for linear gradient generation according to claim 1, wherein the outlet or outlets of each of the third generation channels of the linear gradient generation are connected to inlets of biological material cultivation chambers.

8. An apparatus for logarithmic gradient generation, comprising:
a first generation having a first generation channel, the first generation channel having an inlet, an outlet, and a connection node located in between the inlet and the outlet of the first generation channel;
a first connection channel having an inlet and an outlet, wherein the inlet of the connection channel is connected to the first generation channel at the connection node of the first generation channel;
a second generation having a second generation channel, the second generation channel having an inlet, an outlet, and a first connection node located in between the inlet and the outlet of the second generation channel, wherein the first connection node of the second generation channel is connected to the first connection channel at the outlet end of the first connection channel.

9. The apparatus for logarithmic gradient generation according to claim 8, wherein the second generation channel further comprises a second connection node located between the first connection node and the outlet of the second generation channel, the second connection node being connected to a second connection channel at an inlet of the second connection channel, herein the second connection channel has an inlet and an outlet.

10. The apparatus for logarithmic gradient generation according to claim 8, comprising a number of n generations, wherein n is any integer value that is larger than 1, and wherein each ith (i=1 . . . n) generation has a generation channel, and a connection channel, herein each generation channel has an inlet and an outlet, and wherein each connection channel has an inlet and an outlet.

11. The apparatus for logarithmic gradient generation according to claim 10, wherein for any generation channel that is not the first generation channel, each ith generation channel has a first connection node located in between the inlet and the outlet of the ith generation channel, and a second connection node located in between the first connection node and the outlet of the ith generation channel.

12. The apparatus for logarithmic gradient generation according to claim 11, wherein the first connection node of the ith generation channel is connected to a (i−1)th connection channel at the outlet of the (i−1)th connection channel, and wherein the second connection node of the ith generation channel is connected to an ith connection channel at the inlet of the ith connection channel.

13. The apparatus for logarithmic gradient generation acc ding to claim 8, wherein fluid flow resistance of a channel is varied differently by changing the length of the channels.

14. The apparatus for logarithmic gradient generation according to claim 8, wherein fluid flow resistance of a channel is varied differently by changing the height of the channels.

15. The apparatus for logarithmic gradient generation according to claim 8, wherein fluid flow resistance of a channel is varied differently by changing the width of the channels.

16. The apparatus for logarithmic gradient generation according to claim 11, satisfying R_{Cn}=9×R_{Gn3}, wherein R_{Cn} is the fluid flow resistance of the nth connection channel, and R_{Gn3} is the fluid flow resistance between the second connection node and the outlet of the nth generation channel.

17. The apparatus for logarithmic gradient generation according to claim 11, satisfying R_{Gi3}=(R_{Ci}+10×R_{G(i+1)2}+9×R_{G(i+1)3})/9, (i=1 . . . n−1), wherein R_{Gi3} is the fluid flow resistance between the second connection node and the outlet of ith generation channel, R_{Ci} is the fluid flow resistance of ith connection channel, R_{G(i+1)2} is the fluid flow resistance between the first connection node and the second connection node of the (i+1)th generation channel, and R_{G(i+1)3} is the fluid flow resistance between the second connection node and the outlet of the (i+1)th generation channel.

18. The apparatus for logarithmic gradient generation according to claim 8, wherein each outlet of the generation channels divides in a plurality of outlets.

19. The apparatus for logarithmic gradient generation according to claim 8, wherein the outlet or outlets of each of the logarithmic gradient generation channels are connected to inlets of biological material cultivation chambers.

20. A kit comprising:
a first module comprising a linear gradient generator as claimed in comprising:
a first generation having at least two first generation channels, each first generation channel having an inlet;
a second generation having at least four second generation channels, each second generation channel having a inlet and an outlet, the inlet of each second generation channel being in communication with one of the at least two first generation channels, the outlet of each being in communication with the outlet of one of the other second generation channels, at a crossing point, wherein the inlet of the other second generation channel is in communication with another first generation channel;
a third generation having at least three third generation channels, each third generation channel having an inlet and an outlet;
a least a control channel being connected to one of the at least two first generation channels, the at least a control channel having an inlet and an outlet, wherein the inlet of the at least a control channel is connected with one of the at least two first generation channels, and the outlet of the at least a control channel is connected with an inlet of one of the at least three third generation channels;
where a crossing point between two second generation channels is in communication with an inlet of one of the at least three third generation channels;
wherein the dimensions of the second generation channels that are in communication with a same first generation channel are chosen such that the fluid flow resistances of the second generation channels vary linearly;
wherein the sum of fluid flow resistance of any two second generation channels that are in communication with each other is a predetermined value;
wherein fluid flow resistance of the first generation channels are much less than the second generation channels;
a second module comprising a plurality of biological material cultivation chambers;
wherein the outlets of the third generation channels of the linear gradient generator are connected to inlets of the plurality of biological material cultivation chambers.

21. The kit according to claim 20, further comprising
a third module located between the first module and the second module, wherein the third module provides channels which connect the outlets of the third generation channels of the linear gradient generator and inlets of the plurality of biological material cultivation chambers.

27. The kit according to claim 21,
wherein each channel provided by the third module has at least one inlet and at least one outlet;
wherein the outlet or outlets of each third generation channel of the linear gradient generator is/are connected to at least an inlet of a channel of the third module; and
wherein the at least one outlet of the channel of the third module is connected to an inlet of at least one biological material cultivation chamber.

23. The kit according to claim 20,
wherein the first module further comprises one or more gradient generators,
wherein outlets of the one or more gradient generators are connected to inlets of the plurality of biological material cultivation chambers.

24. A kit comprising:
a first module comprising a logarithmic gradient generator comprising:
a first generation having a first generation channel, the first generation channel having an inlet, an outlet, and a connection node located in between the inlet and the outlet of the first generation channel;
a first connection channel having an inlet and an outlet, wherein the inlet of the connection channel is connected to the first generation channel at the connection node of the first generation channel;
a second generation having a second generation channel, the second generation channel having an inlet, an outlet, and a first connection node located in between the inlet and the outlet of the second generation channel, wherein the first connection node of the second generation channel is connected to the first connection channel at the outlet end of the first connection channel;
a second module comprising a plurality of biological material cultivation chambers;
wherein the outlets of the generation channels of the logarithmic gradient generator are connected to inlets of the plurality of biological material cultivation chambers.

25. The kit according to claim 24, further comprising
a third module located between the first module and the second module, wherein the third module provides channels which connect the outlets of the generation channels of the logarithmic gradient generator and inlets of the plurality of biological material cultivation chambers.

26. The kit according to claim 25,
wherein each channel provided by the third module has at least one inlet and at least one outlet;
wherein the outlet or outlets of each generation channel of the logarithmic gradient generator is/are connected to at least an inlet of a channel of the third module; and
wherein the at least one outlet of the channel of the third module is connected to an inlet of a least one biological material cultivation chamber.

27. The kit according to claim 24,
wherein the first module further comprises one or more gradient generators,
wherein outlets of the one or more gradient generators are connected to inlets of the plurality of biological material cultivation chambers.

28. A kit comprising:
a first module comprising
a linear gradient generator comprising:
a first generation having at least two first generation channels, each first generation channel having an inlet;
a second generation having at least four second generation channels, each second generation channel having a inlet and an outlet, the inlet of each second generation channel being in communication with one of the at least two first generation channels, the outlet of each being in communication with the outlet of one of the other second generation channels, at a crossing point, wherein the inlet of the other second generation channel is in communication with another first generation channel;
a third generation having at least three third generation channels, each third generation channel having an inlet and an outlet;
at least a control channel being connected to one of the at least two first generation channels, the at least a control channel having an inlet and an outlet, wherein the inlet of the at least a control channel is connected with one of the at least two first generation channels, and the outlet of the at least a control; channel is connected with an inlet of one of the at least three third generation channels;
wherein a crossing point between two second generation channels is in communication with an inlet of one of the at least three third generation channels;
wherein the dimensions of the second generation channels that are in communication with a same first generation channel are chosen such that the fluid flow resistances of the second genera on channels vary linearly;
wherein the sum of fluid flow resistance of any two second generation channels that are in communication with each other is a predetermined value;
wherein fluid flow resistance of the first generation channels are much less than the second generation channels; and
a logarithmic gradient generator; comprising:
a first generation having a first generation channel, the first generation channel having an inlet, an outlet, and a connection node located in between the inlet and the outlet of the first generation channel;
a first connection channel having an inlet and an outlet, wherein the inlet of the connection channel is connected to the first generation channel at the connection node of the first generation channel;
a second generation having a second generation channel, the second generation channel having an inlet, an outlet, and a first connection node located in between the inlet and the outlet of the second generation channel, wherein the first connection node of the second generation channel is connected to the first connection channel at the outlet end of the first connection channel;
a second module comprising a plurality of biological material cultivation chambers;
wherein the outlets of the third generation channels of the linear gradient generator are connected to inlets of the plurality of biological material cultivation chambers;
wherein the outlets of the generation channels of the logarithmic gradient generator are connected to inlets of the plurality of biological material cultivation chambers.

29. The kit according to claim 28, further comprising
a third module located between the first module and the second module,
wherein the third module provides channels which connect the outlets of the third generation channels of the linear gradient generator and inlets of a plurality of biological material cultivation chambers, and connect the outlets of the generation channels of the logarithmic gradient generator and inlets of a plurality of biological material cultivation chambers of the second module.

30. The kit according to claim 29,
wherein each channel provided by the third module has at least one inlet and at least one outlet;
wherein the outlet or outlets of each third generation channel of the linear gradient generator is/are connected to at least one inlet of a channel of the third module; and
wherein the outlet or outlets of each generation channel of the logarithmic gradient generator is/are connected to at least one inlet of a channel of the third module; and
wherein the at least one outlet of a channel of the third module is connected to an inlet at least one biological material cultivation chamber.

31. The kit according to claim 28,
wherein the first module further comprises one or more gradient generators,
wherein outlets of the one or more gradient generators are connected to inlets of a plurality of biological material cultivation chambers of the second module.

32. A method of subjecting a biological material located in a cultivation chamber for a test substance, comprising:
providing a linear gradient generator comprising:
a first generation having at least two first generation channels, each first generation channel having an inlet;
a second generation having at least four second generation channels, each second generation channel having a inlet and an outlet, the inlet of each second generation channel being in communication with one of the at least two first generation channels, the outlet of each being in communication with the outlet of one of the other second generation channels, at a crossing point, wherein the inlet of the other second generation channel is in communication with another first generation channel;
a third generation having at least three third generation channels, each third generation channel having an inlet and an outlet;
at least a control channel being connected to one of the at least two first generation channels, the at least a control channel having an inlet and an outlet, wherein the inlet of the at least a control channel is connected with one of the at least two first generation channels, and the outlet of the at least a control channel is connected with an inlet of one of the at least three third generation channels;
wherein a crossing point between two second generation channels is in communication with an inlet of one of the at least three third generation channels;
wherein the dimensions of the second generation channels that are in communication with a same first generation channel are chosen such that the fluid flow resistances of the second generation channels vary linearly;
wherein the sum of fluid resistance of any two second generation channels that are communication with each other is a predetermined value;
wherein fluid flow resistance of the first generation channels are much less than the second generation channels;
providing a plurality of cultivation chambers, each retaining a biological material;
introducing a cultivation medium through an inlet into one of the two first generation channels of the linear gradient generator, and introducing a test substance through an inlet into the other first generation channel of the linear gradient generator, whereby the cultivation medium or the test substance or a mixture of the cultivation medium and the test substance is obtained at the outlet or outlets of each third generation channel of the linear gradient generator;
letting each of the mixtures or the cultivation medium or the test substance flow through at least one of the plurality of cultivation chamber which retains the biological material.

33. A method of subjecting a biological material located in a cultivation chamber to a test substance, comprising:
providing a logarithmic gradient generator comprising:
a first generation having a first generation channel, the first generation channel having an inlet, an outlet, and a connection node located in between the inlet and the outlet of the first generation channel;
a first connection channel having an inlet and an outlet, wherein the inlet of the connection channel is connected to the first generation channel at the connection node of the first generation channel;
a second generation having a second generation channel, the second generation channel having an inlet, an outlet, and a first connection node located in between the inlet and the outlet of the second generation channel, wherein the first connection node of the second generation channel is connected to the first connection channel at the outlet end of the first connection channel;
providing a plurality of cultivation chambers, each retaining a biological material;
introducing a test substance through an inlet into the first generation channel of the logarithmic gradient generator and introducing a cultivation medium through an inlet into other generation channels of the logarithmic gradient generator, whereby the test substance or a mixture of the cultivation medium and the test substance and the test subs is obtained at the outlet or outlets of each generation channel of the logarithmic gradient generator;
letting each of the mixtures or the test substance flow through at least one of the plurality of cultivation chambers which retains the biological material.

34. A method of subjecting a biological material located in a cultivation chamber to a test substance, comprising:
providing a linear gradient generator comprising:
a first generation having at least two first generation channels, each first generation channel having an inlet;
a second generation having at least four second generation channels, each second generation channel having a inlet and an outlet, the inlet of each second generation channel being in communication with one of the at least two first generation channels, the outlet of each being in communication with the outlet of one of the other second generation channels, at a crossing point, wherein the inlet of the other second generation channel is in communication with another first generation channel;
a third generation having at least three third generation channels, each third generation channel having an inlet and an outlet;
at least a control channel being connected to one of the at least two first generation channels, the at least a control channel having an inlet and an outlet, wherein the inlet of the at least a control channel is connected with one of the at least two first generation channels, and the outlet of the at least a control channel is connected with an inlet of one of the at least three third generation channels;
wherein a crossing point between two second generation channels is in communication with an inlet of one of the at least three third generation channels;
wherein the dimensions of the second generation channels that are in communication with a same first generation channel are chosen such that the fluid flow resistance of the second generation channels vary linearly;
wherein the sum of fluid flow resistance of any two second generation channels that are in communication with each other is a predetermined value;
wherein fluid flow resistance of the first generation channels are much less than the second generation channels;
providing a logarithmic gradient generator comprising:
a first generation having a first generation channel, the first generation channel having an inlet, an outlet, and a connection node located in between the inlet and the outlet of the first generation channel;
a first connection channel having an inlet and an outlet, wherein the inlet of the connection channel is connected to the first generation channel at the connection node of the first generation channel;
a second generation having a second generation channel, the second generation channel having an inlet, an outlet, and a first connection node located in between the inlet and the outlet of the second generation channel, wherein the first connection node of the second generation channel is connected to the first connection channel at the outlet end of the first connection channel;
providing a plurality of cultivation chambers, each retaining the biological material;
introducing a cultivation medium through an inlet into one of the two first generation channels of the linear gradient generator, and introducing a test substance through an inlet into the other first generation channel of the linear gradient generator, whereby the cultivation medium or the test substance mixture of the cultivation medium and the test substance is obtained at the outlet or outlets of each third generation channel of the linear gradient generator;
letting each of the mixtures or the cultivation medium or the test substance flow through at least one of the plurality of cultivation chambers which retains the biological material;
introducing a test substance through an inlet into the first generation channel of the logarithmic gradient generator and introducing a cultivation medium through an inlet into other generation channels of the logarithmic gradient generator, whereby the test substance or a mixture of the cultivation medium and the test substance is obtained at the outlet or outlets of each generation channel of the logarithmic gradient generator;
letting each of the mixtures or the test substance flow through at least one of the plurality of cultivation chambers which retains the biological material.

35. The method according to claim 32, further comprising:
providing one or more gradient generators,
introducing a cultivation medium and the test substance through inlets into the one or more gradient generators, whereby the cultivation medium or the test substance or a mixture of the cultivation medium and the test substance is obtained at each outlet or outlets of the one or more gradient generators;
letting each of the mixtures the cultivation medium or the test substance flow through at least one of the plurality cultivation chambers which retains the biological material.

36. The method according to claim 33, further comprising:
providing one or more gradient generators,
introducing a cultivation medium and the test substance through inlets into the one or more gradient generators, whereby the cultivation medium or the test substance or a mixture of the cultivation medium and the test substance is obtained at each outlet or outlets of the one or more gradient generators;
letting each of the mixtures or the cultivation medium or the test substance flow through at least one of the plurality of cultivation chambers which retains the biological material.

37. The method according to claim 34, further comprising:
providing one or more gradient generators,
introducing a cultivation medium and the test substance through inlets into the one or more gradient generators, whereby the cultivation medium or the test substance or a mixture of the cultivation medium and the test substance is obtained at each outlet or outlets of the one or more gradient generators;
letting each of the mixtures or the cultivation medium or the test substance flow through at least one of the plurality of cultivation chambers which retains the biological material.
